(19) United States
(12) Patent Application Publication
(10) Pub. No.: US 2024/0419724 A1
(43) Pub. Date: Dec. 19, 2024

(54) CLIP SEARCH WITH MULTIMODAL QUERIES

(71) Applicant: Tesla, Inc., Austin, TX (US)

(72) Inventors: Matthew Wilson, Austin, TX (US); Tim Zaman, Austin, TX (US); Long Tran, Austin, TX (US)

(21) Appl. No.: 18/746,002

(22) Filed: Jun. 17, 2024

Related U.S. Application Data
(60) Provisional application No. 63/508,995, filed on Jun. 19, 2023.

(51) Int. Cl. G06F 16/56; G06F 16/538; G06V 20/56; H04W 4/44

(52) U.S. Cl. CPC G06F 16/56; G06F 16/538; G06V 20/56; H04W 4/44

(57) ABSTRACT

Systems and methods are described herein to manage and search data generated during operation of a vehicle such as camera data generated by cameras. In an example, a system can obtain data associated with an input representing a query, extract an embedding representing one or more semantic elements, and compare the embedding to one or more predetermined embeddings. The system can select at least one predetermined embedding based on a degree of similarity between the predetermined embedding and the embedding extracted from the query. In examples, the data associated with an image corresponding to the predetermined embedding that was selected can be provided or included in a training dataset.

### CROSS-REFERENCE TO RELATED APPLICATIONS

This application claims the benefit of U.S. Provisional Patent Application No. 63/508,995 filed on Jun. 19, 2023, the contents of which are hereby incorporated by reference in their entirety.

### BACKGROUND

Computing devices and communication networks can be used to exchange data and/or information. For example, a computing device can request data such as data associated with images from another computing device via the communication network. In one example, the images can include images generated by sensors on one or more robotic systems such as vehicles, during operation of the vehicles. But depending on the amount of data involved (e.g., the number of images involved) and the representation of the objects by the images, it can be difficult to quickly and efficiently identify and provide images in response to the request.

### SUMMARY

In view of the above-noted challenges posed in managing data using conventional techniques, there is a desire for improved systems and methods for searching for images relevant to queries.

Aspects of the present disclosure address the above-identified challenges by providing systems and methods to process vehicle data and allow for faster responses to queries. In some embodiments, the systems and methods described herein provide for data associated with images generated by sensors installed on a vehicle to be processed to generate vector representations (also referred to as embeddings and/or the like) of the images. In response to receiving input representing a query, the systems and methods can involve extracting vector representations from the query and comparing the vector representations corresponding to the queries with the vector representations of the earlier-processed data. The disclosed systems and methods can involve selecting data to be provided in response to the query based on the comparison of the vector representations and providing the data to a device involved in the request. By preprocessing the vehicle data and generating vector representations that can then be compared to vector representations extracted from queries, the systems and methods disclosed herein reduce or eliminate the need for centralized systems to execute algorithms on a per-query basis to process the vehicle data and identify and provide images in response to the request. This reduces the overall amount of computing resources needed to respond to each query while also reducing the amount of data communicated between devices when responding to the request. Further, by processing vector representations rather than entire images, the amount of data communicated between devices to satisfy the query can be significantly reduced, conserving computer processing and storage resources, as well as networking resources involved in communicating data between the systems involved.

One or more aspects of the present disclosure relate to the configuration of systems (e.g., systems managed by network service providers) to manage data provided by vehicles to a network service provider. By way of example, aspects of the present application can correspond to the management of data received from a plurality of vehicles. In some embodiments, vehicle data can be associated with (e.g., can include and/or represent) images captured by vision systems (e.g., systems that include one or more cameras) mounted on vehicles as the vehicles drive on a roadway. The captured images can be uploaded to network-based resources, such as data storage services, data processing services, etc., provided by a network service provider. The vehicle data can also include vehicle operational information (e.g., related to aspects of vehicle operation such as speed, steering angle, and/or the like), vehicle parameters (e.g., related to aspects of a state of a vehicle as measured by one or more sensors), sensor configuration information (e.g., related to a position, orientation, intrinsic settings such as focal length and shutter speed, and/or the like of one or more sensors supported by (e.g., installed in or on) a vehicle), sensor values (e.g., related to data generated by one or more sensors supported by the vehicle), environmental information (e.g., related to weather, lighting conditions, and/or the like), and/or the like. The vehicle data can include various data types or formats and can be associated with the captured image data.

In an example, vehicle data received by a network service provider can be managed by the network service provider, and a first, second, and/or third party can obtain access to the vehicle data by operating a computing device in communication with the network service provider. These parties, for example, can include but are not limited to vehicle administrators, vehicle manufacturers, vehicle service providers, vehicle owners and fleet operators, automated vehicle software developers, and/or the like. Accordingly, the network service provider can manage the vehicle data to provide access to the parties as described herein.

For purposes of clarity, the terms “images”, “frames”, and “video clips” are used throughout the present disclosure, and these terms can correspond to each other and/or be used interchangeably where contextually appropriate. For example, a camera installed in and/or on a vehicle can capture the surrounding view at a rate of 30 frames per second (fps) and transmit 10 seconds of the captured surrounding view to the network service provider. In this example, the 10 seconds of the view corresponds to 10 seconds of video clips, having 300 frames, where each frame can include one or more images. The number of frames and the video clip rate are provided merely as an example, and various numbers of images and rates can be used based on a specific application.

One or more aspects of the present disclosure relate to the configuration of access to vehicle data (e.g., provided to one or more parties). For example, a network service provider can facilitate vehicle data management and storage and provide all or certain portions of vehicle data managed by the network service provider in response to requests (representing one or more queries) from the parties. In an example, the network service provider can be configured to process the vehicle data received from a plurality of vehicles and store the vehicle data in a data store (also referred to as a database). In this example, parties can use computing devices to request access to certain portions of the vehicle data, and the network service provider can scan the data store to provide the requested vehicle data to the requesting device. In some embodiments, parties can cause respective devices to request access to certain vehicle data by providing the request as a query. In some embodiments, the query can include (e.g., be represented as) inputs to a computing device related to one or more images or a portion of the image (e.g., objects, signs, signals, roadways, and/or the like). The query can also include (e.g., specify) environmental conditions, such as time of day (nighttime or daytime) and weather conditions such as the presence or absence of snow, rain, clouds, sunshine, and/or the like. Upon receiving the query, the network service provider can facilitate the vehicle data management by scanning the data store, determining that at least a portion of the vehicle data (e.g., one or more images) relates to the query, and provide the requested vehicle data to the parties.

Aspects of the present disclosure relate to a method for searching and identifying portions of data within a dataset. In some embodiments, the method includes obtaining data associated with an input representing a query, the query comprising one or more semantic elements; extracting an embedding representing the one or more semantic elements based on the query; comparing the embedding to at least one predetermined embedding of a set of predetermined embeddings; and selecting the at least one predetermined embedding based on a degree of similarity between the embedding and the at least one predetermined embedding. The method can include providing data associated with an image corresponding to the at least one predetermined embedding to a system maintaining a training dataset. The one or more semantic elements can at least in part correspond to one or more objects represented by the image.

Extracting the embedding representing the one or more semantic elements based on the input can include providing the data associated with the input to a text encoder to cause the text encoder to generate the embedding. In some embodiments, the method includes obtaining the set of predetermined embeddings from a database, the set of predetermined embeddings generated based on the images corresponding to the predetermined embeddings and an image encoder. The image encoder can be configured to receive data associated with images generated by at least one sensor supported by at least one vehicle as input and provide embeddings associated with a latent space as output.

In some embodiments, the at least one predetermined embedding can include at least one first predetermined embedding. The method can include selecting at least one second predetermined embedding of the set of predetermined embeddings based on a second degree of similarity between the at least one second predetermined embedding and other predetermined embeddings of the set of predetermined embeddings. In some embodiments, the input includes a first input, and the method includes providing data associated with a graphical user interface (GUI) to cause a display device to display the GUI representing a set of images comprising the image corresponding to the at least one predetermined embedding. The method can include obtaining data associated with a second input, the second input indicating selection of a different image represented by the GUI and determining at least one second predetermined embedding based on the selection of the different image represented by the GUI. In some embodiments, the method includes selecting at least one third predetermined embedding based on a degree of similarity between the at least one second predetermined embedding and embeddings of the set of predetermined embeddings. In some embodiments, the second input indicates selection of the different image that corresponds to a different embedding of the set of predetermined embeddings.

In some embodiments, the embedding and the set of predetermined embeddings include vector representations corresponding to one or more features in a shared latent space. Selecting the at least one predetermined embedding based on the degree of similarity between the embedding and the at least one predetermined embedding can include determining that the degree of similarity between the embedding and the at least one predetermined embedding satisfies a similarity threshold; and selecting the at least one predetermined embedding based on the degree of similarity satisfying the similarity threshold.

An aspect of the present disclosure relates to a system comprising one or more processors configured to obtain data associated with an input representing a query, the query comprising one or more semantic elements; extract an embedding representing the one or more semantic elements based on the query; compare the embedding to at least one predetermined embedding of a set of predetermined embeddings; select the at least one predetermined embedding based on a degree of similarity between the embedding and the at least one predetermined embedding; and provide data associated with an image corresponding to the at least one predetermined embedding to a system maintaining a training dataset. The one or more semantic elements at least in part correspond to one or more objects represented by the image.

In some embodiments, the one or more processors configured to extract the embedding representing the one or more semantic elements based on the input are configured to: provide the data associated with the input to a text encoder to cause the text encoder to generate the embedding. The one or more processors can be further configured to: obtain the set of predetermined embeddings from a database, the set of predetermined embeddings generated based on the images corresponding to the predetermined embeddings and an image encoder.

The image encoder can be configured to receive data associated with images generated by at least one sensor supported by at least one vehicle as input and provide embeddings associated with a latent space as output. In some embodiments, the at least one predetermined embedding includes at least one first predetermined embedding, and the one or more processors are configured to: select at least one second predetermined embedding of the set of predetermined embeddings based on a second degree of similarity between the at least one second predetermined embedding and other predetermined embeddings of the set of predetermined embeddings.

In some embodiments, the input comprises a first input, and the one or more processors are further configured to: provide data associated with a graphical user interface (GUI) to cause a display device to display the GUI representing a set of images comprising the image corresponding to the at least one predetermined embedding. The one or more processors can be configured to obtain data associated with a second input, the second input indicating selection of a different image represented by the GUI, determine at least one second predetermined embedding based on the selection of the different image represented by the GUI. In some embodiments, the one or more processors are configured to select at least one third predetermined embedding based on a degree of similarity between the at least one second predetermined embedding and embeddings of the set of predetermined embeddings.

In some embodiments, the second input indicates selection of the different image that corresponds to a different embedding of the set of predetermined embeddings. The embedding and the set of predetermined embeddings can include vector representations corresponding to one or more features in a shared latent space. In some embodiments, the one or more processors configured to select the at least one predetermined embedding based on the degree of similarity between the embedding and the at least one predetermined embedding are configured to: determine that the degree of similarity between the embedding and the at least one predetermined embedding satisfies a similarity threshold. The one or more processors can be configured to select the at least one predetermined embedding based on the degree of similarity satisfying the similarity threshold.

At least one aspect relates to a non-transitory computer-readable medium storing instructions thereon that, when executed by one or more processors, cause the one or more processors to: obtain data associated with an input representing a query, the query comprising one or more semantic elements; extract an embedding representing the one or more semantic elements based on the query; compare the embedding to at least one predetermined embedding of a set of predetermined embeddings; and select the at least one predetermined embedding based on a degree of similarity between the embedding and the at least one predetermined embedding. The instructions can cause the one or more processors to provide data associated with an image corresponding to the at least one predetermined embedding to a system maintaining a training dataset. The one or more semantic elements can at least in part correspond to one or more objects represented by the image.

In some embodiments, the instructions to extract the embedding representing the one or more semantic elements based on the input can cause the one or more processors to: provide the data associated with the input to a text encoder to cause the text encoder to generate the embedding.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and can not be to scale.

FIG. 1 depicts a block diagram of an example environment for providing vehicle data management according to one or more embodiments;

FIG. 2A depicts a schematic diagram of an example of a vehicle according to one or more embodiments;

FIG. 2B depicts an environment that corresponds to vehicles according to one or more embodiments;

FIG. 3 depicts an example architecture for implementing a vehicle data management service according to one or more embodiments;

FIG. 4 depicts a block diagram of an example interaction between components of the environment of FIG. 1 according to one or more embodiments;

FIG. 5 depicts a flow chart illustrating a process for managing vehicle data according to one or more embodiments;

FIG. 6 depicts a flow chart illustrating a process for searching for images according to one or more embodiments;

FIGS. 7A-7E depict a schematic diagram of an example implementation of a process for searching for images according to one or more embodiments; and

FIG. 8 depicts an example graphical user interface according to one or more embodiments.

### DETAILED DESCRIPTION

Although certain example embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process can be performed in any suitable sequence and are not necessarily limited to any particular disclosed sequence. Various operations can be described as multiple discrete operations, in turn, in a manner that can be helpful in understanding certain embodiments; however, the order of description should not be construed to imply that these operations are order-dependent. Additionally, the structures, systems, and/or devices described herein can be embodied as integrated components or as separate components. For purposes of comparing various embodiments, certain aspects and advantages of these embodiments are described. Not necessarily all such aspects or advantages are achieved by any particular embodiment. Thus, for example, various embodiments can be carried out in a manner that achieves or optimizes one advantage or group of advantages as taught herein without necessarily achieving other aspects or advantages as can also be taught or suggested herein.

For purposes of clarity, the terms “images,” “frames,” and “video clips” are used throughout the present disclosure, and these terms can correspond to each other and/or be used interchangeably where contextually appropriate. For example, a camera installed in and/or on a vehicle can capture the surrounding view at a rate of 30 frames per second (fps) and transmit 10 seconds of the captured surrounding view to the network service provider. In this example, the 10 seconds of the view corresponds to 10 seconds of video clips, having 300 frames, where each frame can include one or more images. The number of frames and the video clip rate are provided merely as an example, and various numbers of images and rates can be used based on a specific application.

Some approaches for identifying and providing vehicle data to devices controlled by requesting parties can present significant technical challenges. For example, in response to receiving a query (e.g., a request for specific portions of vehicle data in a data store) from a device controlled by a party, a network service provider (e.g., an individual or organization associated with management of one or more network-based resources) can scan each frame of the vehicle data stored in the data store and provide a list of the images included in the related vehicle data that is at least in part responsive to the query. The parties can then cause their computing device to download the data associated with the lists of the related vehicle data and further process (e.g., search) the downloaded vehicle data to find the specific portions of the vehicle data responsive to the query. In this regard, even though the list of the vehicle data can be as large in size relative to the overall amount of data stored in the data store, the parties requesting the vehicle data need to engage with their computing devices to download and further process all of the data to identify the portions of the data that are responsive to the query. Implementing these approaches can be particularly time consuming and prohibitive in the case where thousands, millions, or more images are initially identified and included in the list of the vehicle data. Further, in these examples the systems involved can communicate (e.g., transmit/receive) greater volumes of data than necessary, resulting in wasted computing and networking resources.

In other approaches, a network service provider can provide vehicle data as a bundle of vehicle data in response to queries, causing the computing devices controlled by the parties to download the entire bundle of vehicle data and further process the vehicle data to identify specific portions of the data responsive to the query. For example, where the vehicle data includes a plurality of video clips (including a plurality of images) and the parties' request is for vehicle data representing a vehicle entering a tunnel, the network service provider can provide any video clips that include a tunnel. In this example, even though each video clip includes a few frames that indicate (e.g., represent) a tunnel entrance, the parties need to download the whole video clip and determine the frames that indicate the tunnel entrance. Again, implementing these approaches can be overly time consuming and similarly resource intensive as the volume of images initially identified increases.

To address at least a portion of the above-identified inefficiencies, a network service provider can facilitate vehicle data management to provide the vehicle data to parties more efficiently. For example, a network service provider can process incoming vehicle data. In some embodiments, the incoming vehicle data can include captured image data associated with imaging system data generated by the individual vehicles. The vehicle data (also referred to as vehicle data as described herein) can then be stored in a certain data format, such as an array of vector representations (also referred to as embeddings) of images included in each frame of the vehicle data. In some embodiments, the network service provider can use a machine learning model to identify the vector representation of each image included in each frame of the vehicle data. For example, the machine learning model can be configured to receive as input the vehicle data, identify the various images included in the vehicle, and generate a vector representation of each image. In some embodiments, if the vehicle data is 10 seconds of video clips, having 300 frames, the machine learned model can identify images included in (e.g., corresponding to) each frame. The machine learned model can then convert each identified image into a vector representation. Thus, each image can be stored as a vector representation by associating it with a respective frame. In some embodiments, each frame can include two or more or more images, and this frame can include two or more vector representations associated with each image.

In some embodiments, the network service provider can provide an input interface where the parties can request the vehicle data by using the input interface. In some embodiments, the parties can provide the input (e.g., input represented as a query) in the form of (e.g., in the context of) a string of text or natural human language. In these embodiments, the input can include (e.g., indicate) one or more objects, signs, or signals. Further, in these embodiments, the input can be a combination of the objects, signs, or signals with a logical representation. The input can also include (e.g., indicate) environmental conditions, such as time of day (nighttime or daytime) and weather conditions like snow, rain, clouds, sunshine, and so on. For example, the input can be “images including a vehicle entering a tunnel,” “images including vehicles crossing redlight signal,” “images including a stop sign and a tree,” or “images including a stop sign without including vehicles.” It will be understood that these examples are merely provided for illustration purposes, and the present disclosure does not limit the form and/or the objects, signs, or signals that can be included in the input.

In some embodiments, the network service provider can identify one or more images included in the input query. In some embodiments, the network service provider can utilize one or more machine learned models to extract the images included in (e.g., indicated by) the query. In some embodiments, the network service provider can identify the structure of the query. For example, if the query is “a video frame, including vehicle and tree,” the network service provider can scan its data store to find the video frame that includes both the vehicle and tree. In some embodiments, upon identifying the images based on the query, the network service provider converts the identified images into vector representations. In some embodiments, the network service provider can scan its database to find one or more stored vector representations that are the same or similar to the identified vector representations identified from the query. In some embodiments, the network service provider can then display the video frames that include the vector representations that are the same or similar to the identified vector representations identified from the input query. In some embodiments, the network service provider displays the video frames by prioritizing the frames based on the similarity with the identified vector representations included in the input query.

The network service provider can also manage the vehicle data by grouping the frames of the vehicle data based on images included in the frames. In some embodiments, one or more portions of the vehicle data received from the plurality of vehicles can be stored with a plurality of arrays, where each array represents a vector representation of an image included in each frame. In these embodiments, the arrays can be grouped based on their representing vector representation. For example, video frames that include vector representation related to a vehicle can be grouped together. Thus, when the input query includes an image related to a vehicle, these grouped frames can be provided as the result of the input query without requiring the network service provider to process each frame of the vehicle data.

Although the various aspects will be described in accordance with embodiments and a combination of features, one skilled in the relevant art will appreciate that the examples and combination of features are examples in nature and should not be construed as limiting. More specifically, aspects of the present application can be applicable to various types of vehicle data or vehicle processes. However, one skilled in the relevant art will appreciate that the aspects of the present application are not necessarily limited to application to any particular type of vehicle data, data communications, or interaction between third parties, vehicles, and a network service provider. Further, to facilitate the exchange of vehicle data and to provide for selected customization of data transmissions in an efficient manner, one or more aspects of the present application further correspond to example data structure/organization in which vehicle information is transmitted in accordance with example communication protocols. Such interactions should not be construed as limiting.

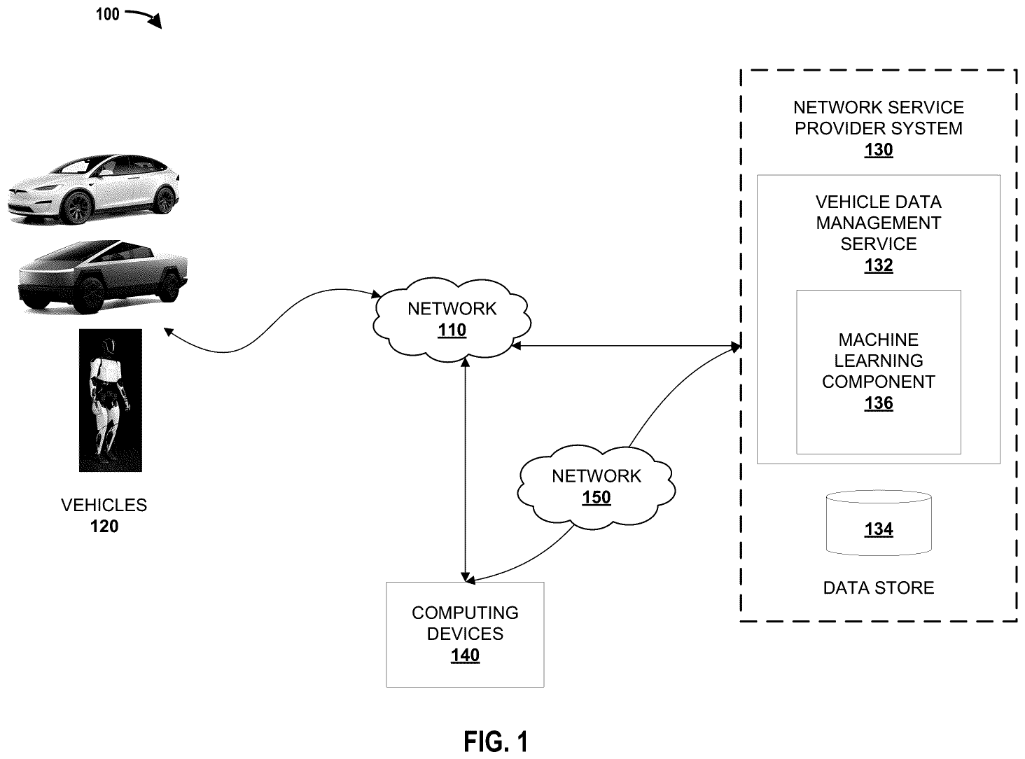

FIG. 1 depicts a block diagram of an environment 100 for providing vehicle data management in accordance with embodiments of the present disclosure. The environment 100 can include a network 110, a plurality of vehicles 120 (referred to collectively as “vehicles 120” and individually as “vehicle 120”), a network service provider system (referred to herein as network service provider 130), and one or more computing devices 140 (referred to collectively as “computing devices 140” and individually as “computing device 140”). In some embodiments, the environment 100 includes a network 150 that can be the same as, or similar to, the network 110. The plurality of vehicles 120, network service provider 130, and/or computing device 140 can be interconnected with (e.g., connected to) each other via the network 110. In some embodiments, some or all of the components of the environment 100 can correspond to hardware (e.g., computing devices and/or components thereof) or software modules implemented or executed by one or more computing devices, which can be separate, stand-alone external computing devices. Accordingly, in some examples, the components of the devices described herein (including the network service provider 130) can be considered as a logical representation of the service that do not necessarily require any specific implementation involving on one or more external computing devices.

In some embodiments, the network 110 can interconnect (e.g., establish communication connections to connect) one or more of the computing devices and/or modules of the environment 100. For example, the vehicles 120, the network service provider 130, and the computing devices 140 can connect via the network 110 to communicate data therebetween. In some embodiments, the network service provider 130 provides network-based services to the vehicles 120, and the computing devices 140 via the network 110. For example, the network service provider 130 can implement network-based services such as a large, shared pool of network-accessible computing resources (e.g., compute, storage, or networking resources, applications, services, and/or the like), which can be implemented using one or more physical computing devices or virtually. In some embodiments, the network service provider 130 can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services.

In some embodiments, the network 110 can be a secured network, such as a local area network that communicates securely via the Internet with the network service provider 130. In examples, the network 110 can include any wired network, wireless network, or combination thereof. For example, the network 110 can be a personal area network, local area network, wide area network, over-the-air broadcast network (e.g., for radio or television), cable network, satellite network, cellular telephone network, or combination thereof. As a further example, the network 110 can be a publicly accessible network of linked networks, possibly operated by various distinct parties, such as the Internet. In some embodiments, the network 110 can be a private or semi-private network, such as a corporate or university intranet. The network 110 can include one or more wireless networks, such as a Global System for Mobile Communications (GSM) network, a Code Division Multiple Access (CDMA) network, a Long Term Evolution (LTE) network, a 5G (5th generation wireless communication), or any other type of wireless network. The network 110 can use (e.g., implement) protocols and components for communicating via the Internet or any of the other aforementioned types of networks. For example, the protocols used by the network 110 can include Hypertext Transfer Protocol (HTTP), HTTP Secure (HTTPS), Message Queue Telemetry Transport (MQTT), Constrained Application Protocol (CoAP), and/or the like.

In some embodiments, the network service provider 130 and the computing device 140 can be connected via a network 150 that is separate from the network 110. In some embodiments, the network 150 includes any combination of wired and/or wireless networks that are the same as, or similar to, the network 110. Examples of the network 150 can include one or more direct communication channels, local area network, wide area network, personal area network, the Internet, and/or the like. In some embodiments, communication between the network service provider 130 and the computing device 140 can be performed via a short-range communication protocol, such as Bluetooth, Bluetooth low energy (“BLE”), and/or near field communications (“NFC”). In some embodiments, the network 150 can be utilized as a backup network of the network 110. For example, when a party (by utilizing the computing device 140) accesses the network service provider 130 via the network 110 and the connection involving the network 110 is disrupted or severed, the network service provider 130 and the computing devices 140 can alternatively communicate via the network 150.

In some embodiments, the networks 110, 150 can include (e.g., implement) some or all of the same communication protocols, services, hardware, and/or the like. Thus, although the discussion herein can describe communication between the network service provider 130 and the computing devices 140 via the network 150 and communication between the vehicles 120 and the network service provider 130 can occur via the network 110, communications of the devices and/or the network-based services are not limited in this manner. The various communication protocols discussed herein are merely examples, and the present application is not limited thereto.

In some embodiments, the vehicles 120 can include one or more vehicles such as one or more robotic systems configured to operate within an environment. The vehicles 120 can include various electronic data sources that transmit data associated with their previous or current navigation sessions to the network service provider system 130. The vehicles 120 can be any apparatus configured for navigation, such as a passenger vehicle, a truck (e.g., a vehicle classified by the United States Department of Transportation (USDOT) as being included in Class 1-8 based on the gross vehicle weight rating (GVWR) of the truck), and/or the like. The vehicles 120 are not limited to being human-operable vehicles and may include robotic devices as well. For instance, the vehicles 120 may include a robot, which may represent a general purpose, bipedal, autonomous humanoid robot capable of navigating various terrains. The robot can be equipped with software that enables balance, navigation, perception, or interaction with the physical world. The robot can also include various cameras configured to transmit visual data to the network service provider system 130.

Even though referred to herein as an “vehicles,” the vehicles 120 may or may not be automated devices configured for automatic navigation. For instance, in some embodiments, the vehicles 120 can be controlled by a human operator or by a system including one or more processors. The vehicles 120 can include various sensors, such as one or more cameras, radar sensors, sound navigation and ranging sensors, light detection and ranging sensors, and/or the like. The sensors can be configured to collect data as the vehicles 120 navigate various terrains (e.g., drivable surfaces such as roads, walkable surfaces such as walkways, and/or the like). In some embodiments, the network service provider 130 can collect data (e.g., vehicle data and/or portions thereof) provided by the vehicles 120. For instance, the network service provider 130 can obtain navigation session and/or road/terrain data (e.g., images generated by sensors of the vehicles 120 while navigating roads) from various sensors, such that the collected data is eventually used by the machine learning component 136 (sometimes referred to as a machine learned component) for training purposes.

In some embodiments, the vehicles 120 can be configured with data storage for storing data generated from electrical components in the vehicle 120. The data, for example, can include log data generated from sensors installed in the vehicle, any processed data related to the vehicle operation such as engine oil data, coolant temperature, milage, oxygen, knocking information from various sensors, etc. The data can also include diagnosed data and automated driving (e.g., self-driving) related data. In one embodiment, the data can be received from an external device.

In some embodiments, the vehicles 120 include communication functionality, including hardware and software, that facilitate interaction via at least one of a plurality of communication mediums and communication protocols. More specifically, the vehicles 120 can include a plurality of sensors, components, and data stores for obtaining, generating and maintaining vehicle data, including operational data, vehicle data, and/or the like. In some embodiments, the information provided by the components can include processed information in which a controller, logic unit, processor, and the like has processed sensor information and generated additional information, such as a vision system that can utilize inputs from one or more camera sensors and provide outputs corresponding to the identification of environmental conditions (e.g., processing of raw camera image data and the generation of outputs corresponding to the processing of the raw camera image information). In some embodiments, the camera sensor can be used to determine the vehicle operational status, environmental status, or other information.

In some embodiments, the network service provider 130 can include a vehicle data management service 132 that can provide functionality responsive to data received from the vehicles 120 or request received from the computing devices 140 (e.g., controlled by parties as described herein). The network service provider 130 can include one or more data stores 134 for storing vehicle data associated with aspects of the present application. The vehicle data management service 132 and data store 134 in FIG. 1 can be logical in nature and can be implemented in the network service provider 130 in a variety of manners. In some embodiments, the vehicle data corresponds to the video image data (e.g., video clips) and any associated metadata or other attributes collected by the vehicle 120. In some embodiments, the video image data can include a plurality of signals, such as vehicle operational parameters, environment attributes, and/or any data generated by the sensors implemented in the vehicle.

In some embodiments, the vehicle data management service 132 can include a machine learning component 136. In some embodiments, the machine learning component 136 can correspond to (e.g., include) one or more neural networks. In some embodiments, the machine learning component 136 can be utilized to process vehicle data (e.g., data received from one or more vehicles as described herein). For example, the machine learning component 136 can be configured to process individual frames included in (e.g., represented by) vehicle data and identify feature(s) of image(s) included in the individual frame. In an example, the machine learning component 136 can represent a feature included in one or more images as a vector representation. These vector representation of the images can be stored in the data store 134 (e.g., in association with the portions of the vehicle data associated with the images).

In some embodiments, the machine learning component 136 can be configured to analyze input, such as an input representing a query. For example, the machine learning component 136 can process the input and identify one or more images related to the input. In some embodiments, the machine learning component 136 can process the input to identify one or more attributes of the image included in the input. For example, the attribute can include but is not limited to objects, signs, signals, roadways, and/or the like. In some embodiments, the machine learning component 136 can process the input to identify logical relationships between the attributes. For example, an input can be represented as a string of text including: “finding images, including a vehicle driving on a highway, entering a tunnel, without including any other vehicles.” In this example, the machine learning component 136 can identify a highway, tunnel, and other vehicles represented by one or more images of one or more frames. The machine learning component 136 can then identify the logical relationships between the identified attributes, as described herein.

In some embodiments, the machine learning component 136 can process a human natural language. In these embodiments, the network service provider 130 can provide the functionality to communicate with a customer (e.g., an artificial intelligence based communication interface), such as a chatbot. In an example, the query can be provided in a context of a human language by communicating with the chatbot, and the machine learning component 136 can identify one or more related images based on the query. The query can also be provided as the context of the text, and the machine learning component 136 can analyze the context and identify the related images based on the query.

In some embodiments, the machine learning component 136 can learn (e.g., be trained to classify) meaningful data characteristics (sometimes referred to as features, image features, and/or the like) directly from images. In these embodiments, the machine learning component 136 can be trained on a large number of images and will adjust its representation of features accordingly. In examples, the machine learning component 136 can have a layered structure that allows the machine learning component 136 to learn a vector representation of features of the images. For example, the first and second layers of a convolutional neural network can correspond to low-level image features such as corners or color conjunctions, while deeper layers of the neural network can correspond to more complex textures or class-specific features.

In some embodiments, a number of different types of algorithms and/or machine learning models can be implemented by the machine learning component 136 to generate the models. For example, certain embodiments herein can use a logistical regression model, decision trees, random forests, convolutional neural networks, deep networks, or others. However, other models are possible, such as a linear regression model, a discrete choice model, or a generalized linear model. The machine learning algorithms can be configured to adaptively develop and update the models over time based on new input received by the machine learning component 136. For example, the models can be regenerated on a periodic basis as new human physical characteristics or bio information is available to help keep the predictions in the model more accurate as the information evolves over time. The machine learning component 136 is described in more detail herein.

Some non-limiting examples of machine learning algorithms that can be used to generate and update the parameter functions or prediction models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms.

These machine learning algorithms can include any type of machine learning algorithm, including hierarchical clustering algorithms and cluster analysis algorithms, such as a k-means algorithm. In some cases, the performing of the machine learning algorithms can include the use of an artificial neural network. By using machine-learning techniques, large amounts (such as terabytes or petabytes) of vehicle data can be analyzed to generate models.

In an example, the computing device 140, as depicted in FIG. 1, can be any computing device such as a desktop, laptop, personal computer, tablet computer, wearable computer, server, personal digital assistant (PDA), hybrid PDA/mobile phone, mobile phone, smartphone, set-top box, voice command device, digital media player, and the like. The computing device 140 can execute an application (e.g., a browser, a stand-alone application, etc.) that allows a user to access interactive user interfaces, view images, analyses, aggregated data, and/or the like as described herein. In some embodiments, technicians and/or software developers can utilize the computing device 140 to authenticate the technician's and/or software developer's credentials to access the vehicle 120 and/or to access the vehicle data.

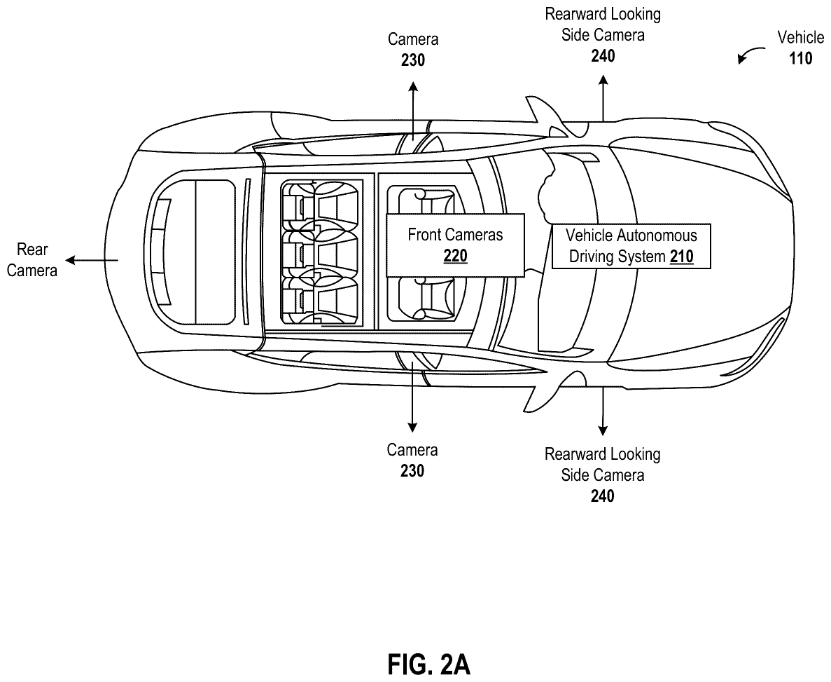

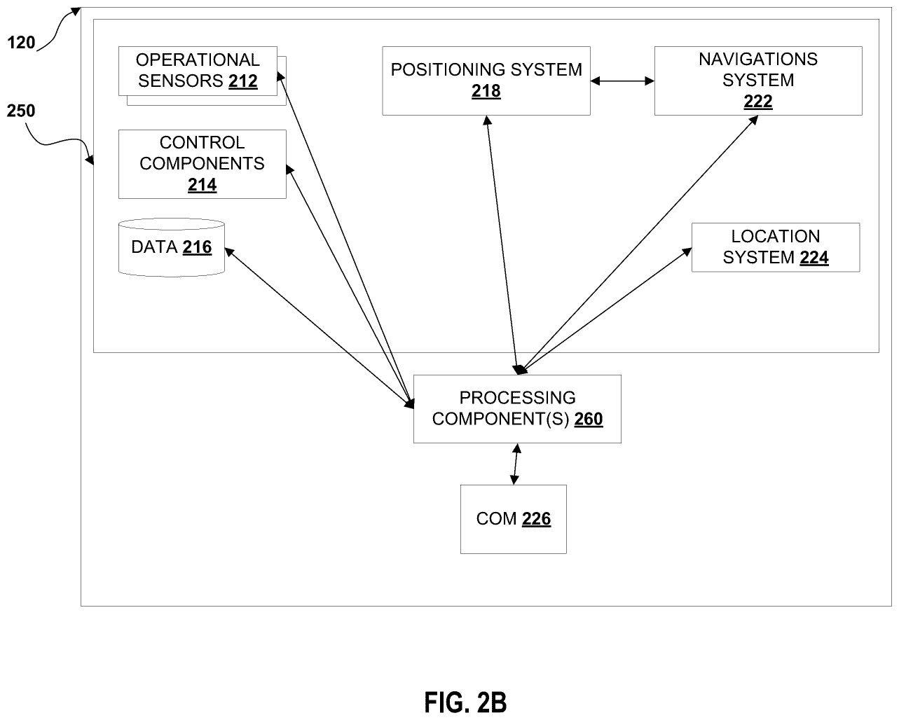

FIG. 2A depicts a schematic diagram of an example of vehicle 120. FIG. 2A shows a top view of the vehicle 120, illustrating the placement of multiple cameras 220, 230, 240 (e.g., cameras configured for mounting at either internal or external vehicle locations). In some embodiments, the vehicle 120 is configured to capture the surrounding images representing an environment in which the vehicle 120 is operating or is configured to operate. In some embodiments, the vehicle 120 has an autonomous driving functionality (e.g., self-driving). In some embodiments, the cameras are positioned in various locations within and outside of the vehicle 120. In an example, in FIG. 2A, front cameras 220 are mounted on the front side of the vehicle 120, such as on the upper side of a front windshield. Pillar cameras 230 are mounted on both sides of the vehicle 120, such as the pillars of the vehicle 120. For example, the pillar cameras 230 can be mounted inside the pillars. Repeater cameras 240 are mounted on both repeater sides of the vehicle 120.

In some embodiments, the cameras 220, 230, 240 capture images of the environment in which the vehicle 120 is operating, including a roadway, pedestrians, and/or vehicles surrounding the vehicle 120. In these embodiments, the front cameras 220 capture front images of the vehicle 120. The pillar cameras 230 are configured to capture images of both sides of the vehicle 120. The repeater cameras 240 are configured to capture behind images of the vehicle 120.

In some embodiments, the vehicle 120 includes at least one controller (not explicitly illustrated) having one or more microprocessors and circuitry configured to establish a wireless communication channel connected with the networks 110, 150. The controller can transmit (e.g., feed or upload) vehicle data associated with the captured images to the network service provider 130 via the networks 110, 150. The captured images also can be encoded as video files based on the resolution specification of each of the cameras.

In some embodiments, the vehicle 120 includes a vehicle autonomous driving system 210. The vehicle autonomous driving system 210 can control the vehicle 120 for autonomous driving (e.g., self-driving including automated operation of the vehicle 120 while operating within an environment based at least in part on sensor signals generated by sensors of the vehicle). The vehicle autonomous driving system 210 can access the captured images and identify surrounding features based on a machine learning model provided by the machine learning component 136. For example, the features can include a light indicator of each surrounding vehicle that is displayed on images captured by the front cameras 220. The features can also include road information such as curbs, painted lines, cones, traffic signals and other items found on roadways. The communication configuration between the cameras 220, 230, 240, and the vehicle autonomous driving system 210 can be either direct or indirect communication via a wired connection using communication cables or a bus. Various wired communication networks, such as a controller area network (CAN), can be used, and network protocol can be specified based on a specific application. The number of cameras and location of the cameras shown in FIG. 2A are intended to represent examples, and the present application does not limit the number of cameras and position of the cameras.

FIG. 2B depicts an environment that corresponds to vehicles 120 in accordance with one or more aspects of the present application. The environment includes a collection of inputs from local sensors 250 that can provide inputs for the operation of the vehicle or collection of information as described herein. The collection of local sensors 250 can include one or more sensor or sensor-based systems included with a vehicle or otherwise accessible by a vehicle during operation. The local sensors or sensor systems can be integrated into the vehicle. Alternatively, the local sensors or sensor systems can be provided by interfaces associated with a vehicle, such as physical connections, wireless connections, or a combination thereof.

In one aspect, the local sensors 250 can include vision systems that provide inputs to the vehicle, such as detection of objects, attributes of detected objects (e.g., position, velocity, acceleration), presence of environment conditions (e.g., snow, rain, ice, fog, smoke, etc.), and the like. For example, the vehicle 120 can include a plurality of cameras, operational sensors 212, control components 214, and data 216. In this example, the operational sensors 212 can provide the vehicle operational parameters to processing component 260 in real time. The control components 214 can provide data related to controlling the vehicle, such as steering wheel direction, acceleration, braking, etc. The data 216 can provide any stored information related to the current vehicle operational environment, such that if the vehicle 120 is driving on a highway, the data 216 can provide driving information, including the speed limit of the highway, number of traffic lines, etc. The types of data 216 are not limited in this disclosure, and the types of data can be any data that can be utilized in autonomous driving by utilizing the vision system. In some embodiments, vehicles 120 can rely on such vision systems for defined vehicle operational functions, including capturing visual positioning information or positioning cues in accordance with aspects of the present application.

In yet another aspect, the local sensors 250 can include one or more positioning systems 218 that can obtain reference information from external sources that allow for various levels of accuracy in determining positioning information for a vehicle. For example, the positioning systems 218 can include various hardware and software components for processing information from GPS sources, Wireless Local Area Networks (WLAN) access point information sources, Bluetooth information sources, radio-frequency identification (RFID) sources, and the like. In some embodiments, the positioning systems 218 can obtain combinations of information from multiple sources. In examples, the positioning systems 218 can obtain information from various input sources and determine positioning information for a vehicle, such as an elevation at a current location. In other embodiments, the positioning systems 218 can also determine travel-related operational parameters, such as the direction of travel, velocity, acceleration, and the like. The positioning system 218 can be configured as part of a vehicle for multiple purposes, including self-driving applications, enhanced driving or user-assisted navigation, and the like. In examples, the positioning systems can include processing components and data that facilitate the identification of various vehicle parameters or process information.

In still another aspect, the local sensors can include one or more navigation system 222 for identifying navigation related information. In examples, the navigation systems 222 can obtain positioning information from positioning systems 218 and identify characteristics or information about the identified location, such as elevation, road grade, etc. The navigation systems 222 can also identify suggested or intended lane locations in a multi-lane road based on directions that are being provided or anticipated for a vehicle user. Similar to the location systems 224, the navigation system can be configured as part of a vehicle for multiple purposes, including self-driving applications, enhanced driving or user-assisted navigation, and the like. The navigation systems 222 can be combined or integrated with positioning systems 218. In examples, the positioning systems 218 can include processing components and data that facilitate the identification of various vehicle parameters or process information.

The local resources further include one or more processing component(s) 260 that can be hosted on the vehicle or a computing device accessible by a vehicle (e.g., a mobile computing device). The processing component(s) 260 can access inputs from various local sensors or sensor systems and process the inputted data and store the processed data. For purposes of the present application, the processing component(s) 260 will be described with regard to one or more functions related to example aspects. For example, processing component(s) in the vehicle 120 can verify authorized entities or individuals who can access the vehicle data and collect and transmit the data set corresponding to the request from the authorized entities and/or technicians. The processing component(s) 260 can communicate with other vehicle components and the authorized entities and/or technicians via com 226 (e.g., a communications interface such as a network interface that enables communication via the networks 110, 150 as described herein). For example, the com 226 can provide the verification information or vehicle data by utilizing vehicle communication buses or one or more vehicle interfaces configured to utilize the networks 110, 150.

The environment can further include various additional sensor components or sensing systems operable to provide information regarding various operational parameters for use in accordance with one or more of the operational states. The environment can further include one or more control components for processing outputs, such as the transmission of data through a communications output, the generation of data in memory, the transmission of outputs to other processing components, and the like.

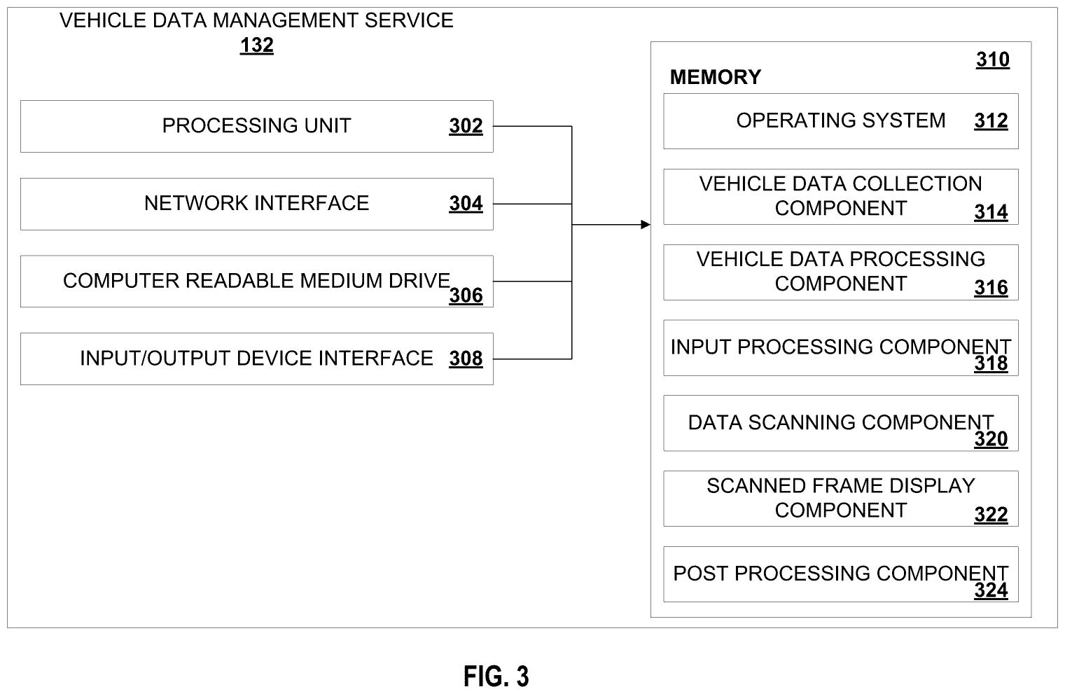

FIG. 3 depicts an example architecture for implementing a vehicle data management service 132. The vehicle data management service 132 can be part of components/systems that can provide functionality associated with processing and storing vehicle data and providing access to the stored data for parties as described herein by receiving a request or input from the parties as the parties engage the computing device 140.

The architecture of FIG. 3 is an example in nature and should not be construed as requiring any specific hardware or software configuration for the vehicle data management service 132. The general architecture of the vehicle data management service 132 is depicted in FIG. 3 includes an arrangement of computer hardware and software components that can be used to implement aspects of the present disclosure. As illustrated, the vehicle data management service 132 includes a processing unit 302, a network interface 304, a computer readable medium drive 306, and an input/output device interface 308, all of which can communicate with one another by way of a communication bus. The components of the vehicle data management service 132 can be physical hardware components that can include one or more circuitries and software models.

The network interface 304 can provide connectivity to one or more networks or computing systems, such as the networks 110, 150 of FIG. 1. The processing unit 302 can thus receive information and instructions from other computing systems or services via the networks 110, 150. The processing unit 302 can also communicate to and from memory 310 and further provide output information via the input/output device interface. In some embodiments, the vehicle data management service 132 can include more (or fewer) components than those shown in FIG. 3.

The memory 310 can include computer program instructions that the processing unit 302 executes in order to implement one or more embodiments. The memory 310 generally includes RAM, ROM, or other persistent or non-transitory memory. The memory 310 can store an operating system 312 that provides computer program instructions for use by the processing unit 302 in the general administration and operation of the vehicle data management service 132. The memory 310 can further include computer program instructions and other information for implementing aspects of the present disclosure.

The memory 310 can include the vehicle data collection component 314. The vehicle data collection component 314 can be configured to receive the vehicle data from a plurality of vehicles. In some embodiments, the vehicles can be configured to collect data (e.g., vehicle data as described herein) and transmit the collected data. In these embodiments, the data can be vision system data. For example, the collected vision system data can be transmitted based on periodic timeframes or various collection/transmission criteria. Still further, in some embodiments, the vehicles can also be configured to identify specific scenarios or locations, such as via geographic coordinates or other identifiers, that will result in the collection and transmission of the collected data.

The memory 310 can include the vehicle data processing component 316. The vehicle data processing component 316 can be configured to process individual frames of the collected data to represent images included in the frame as vector representations of each image. In some embodiments, the vehicle data processing component 316 can utilize the machine learning component 136 to identify the vector representation of each image included in the vehicle data. For example, each pixel in the image can be converted into a numerical value. In examples, if an image has dimensions of 256 pixels by 256 pixels, this image can be flattened into a vector of 65,536 (256×256) elements. Each element in the vector can represent the intensity value of a pixel, ranging from 0 (black) to 255 (white). In some embodiments, the machine learning component 136 can extract features from the images.

In some example embodiments, the machine learning component 136 with a specified number of layers (e.g., ResNet-50) can be trained on a set of images that are labeled with object categories (e.g., cats, dogs, cars, etc.). For example, the model can be trained on a set that includes 1,000 images of cats, 1,000 images of dogs, 1,000 images of books, and so forth. Alternatively, the machine learning component 136 that has been pre-trained on a set of images, can be obtained. The machine learning component 136 can then be fine-tuned by initializing most of the layers of the model with the weights obtained from the trained or pre-trained model but initializing the last k layers of the model randomly, where k is a small number relative to the number of layers in the model (e.g., 3 out of 50). The model can also be trained to be invariant with regard to various image transformations by applying these transformations to images in the training set (e.g., scaling the images, converting them to grayscale, rotating them, adding random noise, changing their brightness or contrast, etc.) and then training the model to produce a feature vector representation for a transformed image that does not vary significantly from the feature vector representation of the original image. The model can thus be trained to generate “similar” feature vector representations (measured in terms of, e.g., relatively low Euclidean or L2 distances between the feature vectors) for images that are similar to each other.

In some embodiments, the vehicle data processing component 316 can process each video clip received from the vehicles and process the video clips into the array of vectors that can form a vector representation. Each vector representation can be associated with an image and the frame of the video clip that includes the image. In some embodiments, the vehicle data processing component 316 can also process the vehicle data by grouping the vehicle data based on images, having a similar vector representation. For example, the frames that include at least a common or similar vector representation can be grouped. In these embodiments, if a frame includes two or more images, the frame can be grouped into two or more groups, each group associated with at least one of the images. For example, if a frame includes a cat and a dog, the frame can be grouped into a group associated with a vector representation of a cat and another group associated with a vector representation of a dog.

The memory 310 can include the input processing component 318. The input processing component 318 can be configured to receive input from the parties described herein, such as vehicle administrator(s), vehicle manufacturer(s), vehicle service provider(s), vehicle owner(s), automated vehicle software developers, and/or the like. The input can also generally be referred to as a query. In some embodiments, the input processing component 318 analyzes the query or queries to identify one or more images included in the queries. In examples, the input processing component 318 identifies images and attributes (e.g., features) of the images included in the queries. For example, the query can include and/or represent one or more attributes of the image. For example, the attributes can include (e.g., indicate) objects, signs, signals, roadways, etc. In this illustration, the input processing component 318 can identify these images and determine a vector representation corresponding to each image included in the query. In some embodiments, the input processing component 318 identifies the structure of the query (e.g., logical representation between the attributes), such that the structure includes actions such as adding two or more attributes or negating one or more attributes. For example, the query can be “images with a road sign and at least one vehicle” or “images with a road sign and without any vehicles.” In some embodiments, the input processing component 318 utilizes the machine learning component 136 to analyze the input queries. In these embodiments, the input queries can be represented using human natural languages, and the input queries can be provided by a communication model embedded in the machine learning component 136, such as a chatbot. For example, a context of human natural language is provided to the chatbot, and the input processing component 318, by utilizing the machine learning component 136, can identify the images and structure included in the query represented by the human natural language.

The memory 310 can include the data scanning component 320. The data scanning component 320 can be configured to scan the metadata stored in the data store 134. In some embodiments, the data scanning component 320 can set a scanning parameter based on the identified images from the input processing component 318. In some embodiments, the data scanning component 320 can scan the data store 134 to identify frames that include the identified images. In examples, the data scanning component 320 receives identified vector representation(s) of images included in the input queries from the input processing component 318 and scans the data store 134 to find the images, having the same or similar vector representation with the images included in the input queries. In some embodiments, the data scanning component 320 can scan the data store 134 based on the vector representation of the images included in the input queries and the structure of the input queries. For example, if the input query is “find images with road signs and without a vehicle,” the data scanning component 320 can scan the data store 134 to find frames that include images having the same or similar vector representation of the road signs without having the vector representation related to the vehicle.

The memory 310 can include the scanned image display component 322. The scanned image display component 322 can be configured to display frames that include images similar to the input query (e.g., the result of scanned images) based on the similarity between the images included in the input query and the images stored in the data store 134. As described in the embodiments of the data scanning component 320, the similarity can be based on the similarity of the vector representation of the images included in the input query and the images stored in the data store 134.

The memory 310 can further include the post processing component 324. In some embodiments, the post processing component 324 can further identify the post input query. The post input query can be provided as the context of the text or human language, and the input processing component 318 can process the post input query according to the embodiments disclosed in the above input processing component 318. In some embodiments, the post input query can be provided by selecting one or more frames displayed by the scanned image display component 322. In these embodiments, when the post input query is provided, the displayed frames can be automatically refined based on the post input query. For example, if the scanned image display component 322 displays frames with a road sign and a frame with a vehicle is selected (e.g., by a party as described herein), the post processing component 324 can identify the post query as “the road sign with a vehicle.” Then, the post processing component 324 can automatically refine the results of the displayed scanned frames (e.g., frames that include road signs) based on the identified post query. Thus, in this example, as result of the refinement, only frames with road signs and vehicles can be displayed.

In some embodiments, the post processing component 324 can provide data to retrain and/or update the machine learning component 136. For example, the parties described herein can provide input to computing devices identifying one or more frames (e.g., displayed scanned frames) that include incorrect images from the input query. In this example, the third party can provide correct images, and these correct images can be utilized to retrain the machine learning component 136. For example, if the input query includes a road sign with “yield” and the displayed frame includes a sign with “yellow,” the third party can flag the frames with “yellow,” and the machine learning component 136 can be trained to distinguish between the sign “yield” and “yellow.”

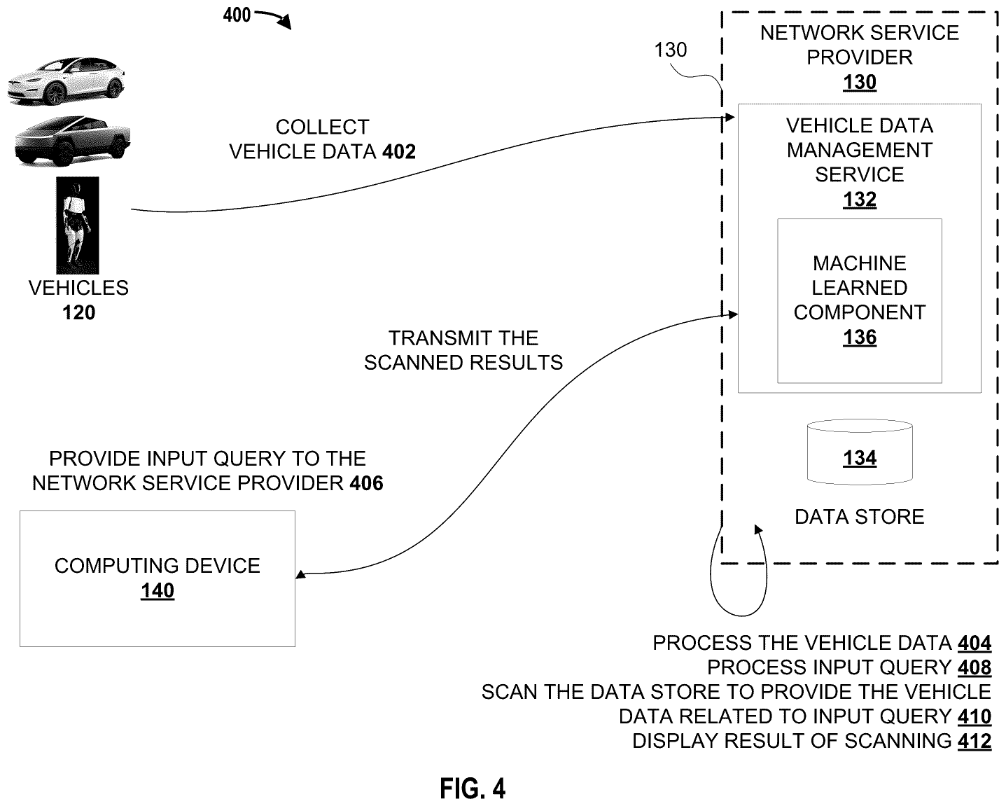

FIG. 4 depicts a block diagram of an example interaction 400 between components of the environment of FIG. 1. Although only a single interaction 400 is illustrated, the present application is not limited to a single interaction.

At step 402, a vehicle data management service 132 collects vehicle data generated from one or more vehicles 120. In some embodiments, the vehicle data management service 132 can be configured to receive the vehicle data from a plurality of vehicles. In some embodiments, the vehicles can be configured to collect data and transmit the collected data. In these embodiments, the data can be vision system data. For example, the collected vision system data can be transmitted based on periodic timeframes or various collection/transmission criteria. Still further, in some embodiments, the vehicles can also be configured to identify specific scenarios or locations, such as via geographic coordinates or other identifiers, that will result in the collection and transmission of the collected data.

At step 404, the vehicle data management service 132 processes the vehicle data. The vehicle data management service 132 can be configured to process individual frames of the collected data to represent images included in the frame as vector representations of each image. In some embodiments, the vehicle data management service 132 can utilize the machine learning component 136 to identify the vector representation of each image included in the vehicle data. For example, each pixel in the image can be converted into a numerical value. In examples, if an image has dimensions of 256 pixels by 256 pixels, this image can be flattened into a vector of 65,536 (256×256) elements. Each element in the vector can represent the intensity value of a pixel, ranging from 0 (black) to 255 (white). In some embodiments, the machine learning component 136 can extract features from the images.

In some example embodiments, the machine learning component 136 with a specified number of layers (e.g., ResNet-50) can be trained on a set of images that are labeled with object categories (e.g., cats, dogs, cars, etc.). For example, the model can be trained on a set that includes 1,000 images of cats, 1,000 images of dogs, 1,000 images of books, and so forth. Alternatively, the machine learning component 136 that has been pre-trained on a set of images, can be obtained. The machine learning component 136 can then be fine-tuned by initializing most of the layers of the model with the weights obtained from the trained or pre-trained model but initializing the last k layers of the model randomly, where k is a small number relative to the number of layers in the model (e.g., 3 out of 50). The model can also be trained to be invariant with regard to various image transformations by applying these transformations to images in the training set (e.g., scaling the images, converting them to grayscale, rotating them, adding random noise, changing their brightness or contrast, etc.) and then training the model to produce a feature vector representation for a transformed image that does not vary significantly from the feature vector representation of the original image. The neural network can thus be trained to generate “similar” feature vector representations (measured in terms of, e.g., relatively low Euclidean or L2 distances between the feature vectors) for images that are similar to each other.

In some embodiments, the vehicle data management service 132 can process each video clip received from the vehicles and process the video clips into the array of vectors. Each vector can be associated with an image and the frame of the video clip that includes the image. In some embodiments, the vehicle data management service 132 can also process the vehicle data by grouping the vehicle data based on images, having a similar vector representation. For example, the frames that include at least a common or similar vector representation can be grouped. In these embodiments, if a frame includes two or more images, the frame can be grouped into two or more groups, each group associated with at least one of the images. For example, if a frame includes a cat and a dog, the frame can be grouped into a group associated with a vector representation of a cat and another group associated with a vector representation of a dog.

At step 406, the party using the computing device 140 can provide input to the vehicle data management service 132. In some embodiments, the computing device 140 can include an interface to provide the input query. In examples, the input query can include images and/or attributes (e.g., features) of the images. For example, the attributes can include objects, signs, signals, roadways, etc. The interface also can receive the input query in the form of a logical representation between the attributes, such that the representation can include actions such as adding two or more attributes or negating one or more attributes. For example, the query can be “images with a road sign and at least one vehicle” or “images with a road sign and without any vehicles.” In some illustrations, the interface can be a chatbot, so the input query can be provided as human natural languages. In some embodiments, the chatbot can be a communication model embedded in the machine learning component 136. In some embodiments, the input query can be provided as a form of context of text. In some embodiments, the input query can be provided with the structure of the query, such that the structure includes actions such as adding two or more images or negating one or more images. For example, the input query can be “images with a road sign and at least one vehicle” or “images with a road sign and without any vehicles.”

At step 408, the vehicle data management service 132 processes the input query. The vehicle data management service 132 can be configured to receive input from the third parties, such as vehicle administrator(s), vehicle manufacturer(s), vehicle service provider(s), vehicle owner(s), automated vehicle developers, and/or the like. The input can also generally be referred to as a query.

In some embodiments, the vehicle data management service 132 can process the input query and identify one or more images related to the input query. In some embodiments, the vehicle data management service 132 can process the input query to identify one or more attributes of the image included in the input query. For example, the attribute can include but is not limited to objects, signs, signals, roadways, etc. In some embodiments, the vehicle data management service 132 can process the input query to identify logical relationships between the attributes. For example, if the input query is “finding images, including a vehicle driving on a highway, entering a tunnel, without including any other vehicles.” In this example, the vehicle data management service 132 identifies the highway, tunnel, and other vehicles. Then, the vehicle data management service 132 can identify the logical relationship between the identified attributes. In some embodiments, the vehicle data management service 132 can identify these images and determine a vector representation corresponding to each attribute or image included in the query. In some embodiments, the input query can be provided as human natural language. In these embodiments, the input queries can be provided by a communication model embedded in the machine learning component 136, such as a chatbot. For example, a context of human natural language is provided to the chatbot, and the vehicle data management service 132 by utilizing the machine learning component 136, can identify the images and structure included in the human natural language.

At step 410, the vehicle data management service 132 scans the data store 134 to provide the vehicle data related to the input query. The vehicle data management service 132 can be configured to scan the metadata stored in the data store 134. In some embodiments, the vehicle data management service 132 can set the scanning parameter based on the identified images from the input query. In some embodiments, the vehicle data management service 132 can scan the data store 134 to identify frames that include the identified images. In examples, the vehicle data management service 132 scans the data store 134 to find the images, having the same or similar vector representation with the images included in the input query. In some embodiments, the vehicle data management service 132 can scan the data store 134 based on the vector representation of the images included in the input queries and the structure of the input query. For example, if the input query is “find images with road signs and without a vehicle,” the vehicle data management service 132 can scan the data store 134 to find frames that include images having the same or similar vector representation for the road signs without having the vector representation related to the vehicle.

At step 412, the vehicle data management service 132 displays the results of scanning the data store 134. The vehicle data management service 132 can be configured to display the frames that include images similar to the input query (e.g., the result of scanned images) based on the similarity between the images included in the input query and the images stored in the data store 134. As described in the embodiments of the vehicle data management service 132, the similarity can be based on the similarity of the vector representation of the images included in the input query and the images stored in the data store 134.

In some embodiments, the vehicle data management service 132 can additionally perform post processing. In these embodiments, the vehicle data management service 132 can further identify the post input query. The post input query can be provided as the context of the text or human language, and the vehicle data management service 132 can further process the post input query according to the embodiments disclosed in the above at 408. In some embodiments, the post input query can be provided by selecting one or more frames displayed at 412. In these embodiments, when the post input query is provided, the displayed frames can be automatically refined based on the post input query. For example, if the vehicle data management service 132 displays frames with a road sign and a frame with a vehicle is selected (e.g., by parties as described herein), the vehicle data management service 132 can further identify the post query as “the road sign with a vehicle.” Then, the vehicle data management service 132 can automatically refine the results of the displayed scanned frames (e.g., frames that include road signs) based on the identified post query. Thus, in this example, as result of the refinement, only frames with road signs and vehicles can be displayed.

In some embodiments, the vehicle data management service 132 can provide data to retrain the machine learning component 136. For example, the third party can identify one or more frames (e.g., displayed scanned frames) that include incorrect images from the input query. In this example, the third party can provide correct images, and these correct images can be utilized to retrain the machine learning component 136. For example, if the input query includes a road sign with “yield” and the displayed frame includes a sign with “yellow,” the third party can flag the frames with “yellow,” and the machine learning component 136 can be trained to distinguish between the sign “yield” and “yellow.”

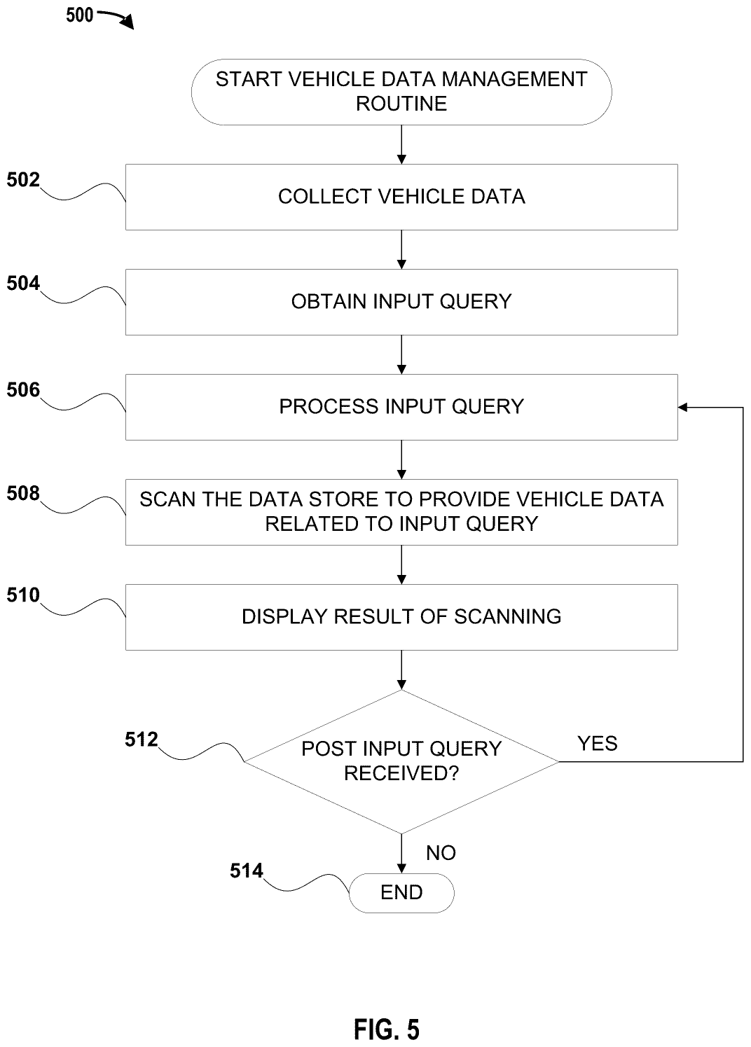

FIG. 5 depicts a flow chart illustrating a process 500 for managing vehicle data. In some embodiments, the process 500 is implemented by the processing component implemented in vehicle data management service 132. The process 500 illustrated in FIG. 5 is an example in nature and should not be construed as limiting.

At step 502, the vehicle data management service 132 collects the vehicle data generated from the plurality of vehicles. The vehicle data management service 132 can be configured to receive the vehicle data from a plurality of vehicles. In some embodiments, the vehicles can be configured to collect data and transmit the collected data. In these embodiments, the data can be vision system data. For example, the collected vision system data can be transmitted based on periodic timeframes or various collection/transmission criteria. Still further, in some embodiments, the vehicles can also be configured to identify specific scenarios or locations, such as via geographic coordinates or other identifiers, that will result in the collection and transmission of the collected data.

In some embodiments, the vehicle data management service 132 processes the vehicle data. The vehicle data management service 132 can be configured to process individual frames of the collected data to represent images included in the frame as vector representations of each image. In some embodiments, the vehicle data management service 132 can utilize the machine learning component 136 to identify the vector representation of each image included in the vehicle data. For example, each pixel in the image can be converted into a numerical value. In examples, if an image has dimensions of 256 pixels by 256 pixels, this image can be flattened into a vector of 65,536 (256×256) elements. Each element in the vector can represent the intensity value of a pixel, ranging from 0 (black) to 255 (white). In some embodiments, the machine learning component 136 can extract features from the images.

In some example embodiments, the machine learning component 136 with a specified number of layers (e.g., ResNet-50) can be trained on a set of images that are labeled with object categories (e.g., cats, dogs, cars, etc.). For example, the model can be trained on a set that includes 1,000 images of cats, 1,000 images of dogs, 1,000 images of books, and so forth. Alternatively, the machine learning component 136 that has been pre-trained on a set of images, can be obtained. The machine learning component 136 can then be fine-tuned by initializing most of the layers of the model with the weights obtained from the trained or pre-trained model, but initializing the last k layers of the model randomly, where k is a small number relative to the number of layers in the model (e.g., 3 out of 50). The model can also be trained to be invariant with regard to various image transformations by applying these transformations to images in the training set (e.g., scaling the images, converting them to grayscale, rotating them, adding random noise, changing their brightness or contrast, etc.) and then training the model to produce a feature vector representation for a transformed image that does not vary significantly from the feature vector representation of the original image. The neural network can thus be trained to generate “similar” feature vector representations (measured in terms of, e.g., relatively low Euclidean or L2 distances between the feature vectors) for images that are similar to each other.

In some embodiments, the vehicle data management service 132 can process each video clip received from the vehicles and process the video clips into the array of vectors. Each vector can be associated with an image and the frame of the video clip that includes the image. In some embodiments, the vehicle data management service 132 can also process the vehicle data by grouping the vehicle data based on images, having a similar vector representation. For example, the frames that include at least a common or similar vector representation can be grouped. In these embodiments, if a frame includes two or more images, the frame can be grouped into two or more groups, each group associated with at least one of the images. For example, if a frame includes a cat and a dog, the frame can be grouped into a group associated with a vector representation of a cat and another group associated with a vector representation of a dog.

At step 504, the vehicle data management service 132 obtains input queries from the third party. The third party by utilizing the computing device 140 can provide input to the vehicle data management service 132. In some embodiments, the computing device 140 can include an interface to provide the input query. In examples, the input query can include images and/or attributes (e.g., features) of the images. For example, the attributes can include objects, signs, signals, roadways, etc. The interface also can provide to receive the input query in a form of logical representation between the attributes, such that the representation can include actions such as adding two or more attributes or negating one or more attributes. For example, the query can be “images with a road sign and at least one vehicle” or “images with a road sign and without any vehicles.” In some embodiments, the interface can be a chatbot, so the input query can be provided as human natural languages. In some embodiments, the chatbot can be a communication model embedded in the machine learning component 136. In some embodiments, the input query can be provided as a form of the context of text. In some embodiments, the input query can be provided with the structure of the query, such that the structure includes actions such as adding two or more images or negating one or more images. For example, the input query can be “images with a road sign and at least one vehicle” or “images with a road sign and without any vehicles.”

At step 506, the vehicle data management service 132 processes the input query. The vehicle data management service 132 can be configured to receive input from the third parties, such as vehicle administrator(s), vehicle manufacturer(s), vehicle service provider(s), vehicle owner(s), automated vehicle developers, and/or the like. The input can also generally be referred to as a query.

In some embodiments, the vehicle data management service 132 can process the input query and identify one or more images related to the input query. In some embodiments, the vehicle data management service 132 can process the input query to identify one or more attributes of the image included in the input query. For example, the attribute can include but is not limited to objects, signs, signals, roadways, etc. In some embodiments, the vehicle data management service 132 can process the input query to identify logical relationships between the attributes. For example, if the input query is “finding images, including a vehicle driving on a highway, entering a tunnel, without including any other vehicles.” In this example, the vehicle data management service 132 identifies the highway, tunnel, and other vehicles. Then, the vehicle data management service 132 can identify the logical relationship between the identified attributes. In some embodiments, the vehicle data management service 132 can identify these images and determine a vector representation corresponding to each attribute or image included in the query. In some embodiments, the input query can be provided as human natural language. In these embodiments, the input queries can be provided by a communication model embedded in the machine learning component 136, such as a chatbot. For example, a context of human natural language is provided to the chatbot, and the vehicle data management service 132 by utilizing the machine learning component 136, can identify the images and structure included in the human natural language.

At step 508, the vehicle data management service 132 scans the data store 134 to provide the vehicle data related to the input query. The vehicle data management service 132 can be configured to scan the metadata stored in the data store 134. In some embodiments, the vehicle data management service 132 can set the scanning parameter based on the identified images from the input query. In some embodiments, the vehicle data management service 132 can scan the data store 134 to identify frames that include the identified images. In examples, the vehicle data management service 132 scans the data store 134 to find the images, having the same or similar vector representation with the images included in the input query. In some embodiments, the vehicle data management service 132 can scan the data store 134 based on the vector representation of the images included in the input queries and the structure of the input query. For example, if the input query is “find images with road signs and without a vehicle,” the vehicle data management service 132 can scan the data store 134 to find frames that include images having the same or similar vector representation for the road signs without having the vector representation related to the vehicle.

At step 510, the vehicle data management service 132 displays the results of scanning the data store 134. The vehicle data management service 132 can be configured to display the frames that include images similar to the input query (e.g., the result of scanned images) based on the similarity between the images included in the input query and the images stored in the data store 134. As described in the embodiments of the vehicle data management service 132, the similarity can be based on the similarity of the vector representation of the images included in the input query and the images stored in the data store 134.

At step 512, the vehicle data management service 132 determines whether the vehicle data management service 132 received post input query from the third party. In some embodiments, the vehicle data management service 132 can further identify the post input query. The post input query can be provided as the context of the text or human language. After determining that the vehicle data management service 132 received the post query, the process 500 returns to step 506. In some embodiments, the post input query can be provided by selecting one or more frames displayed. In these embodiments, when the post input query is provided, the displayed frames can be automatically refined based on the post input query. For example, if the vehicle data management service 132 displays frames with a road sign and a frame with a vehicle is selected (e.g., by the third party), the vehicle data management service 132 can further identify the post query as “the road sign with a vehicle.” Then, the vehicle data management service 132 can automatically refine the results of the displayed scanned frames (e.g., frames that include road signs) based on the identified post query. Thus, in this example, as result of the refinement, only frames with road signs and vehicles can be displayed. If the post input query is not provided, the process 500 can be ended at step 514.

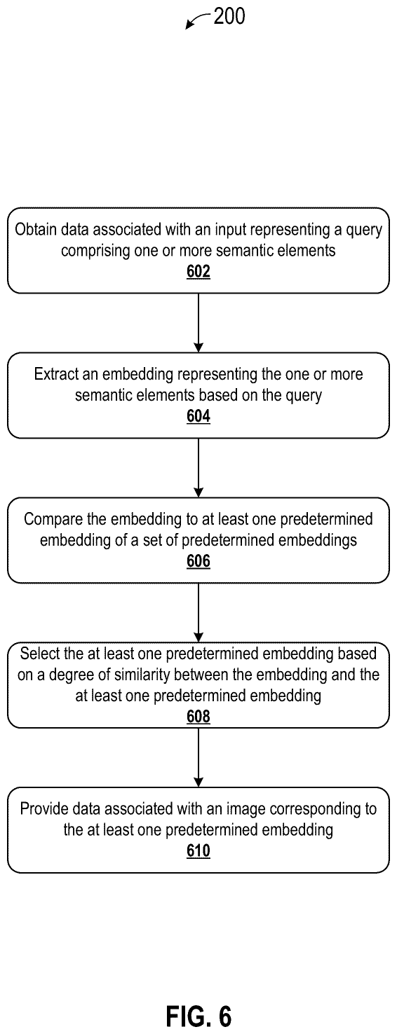

FIG. 6 depicts a flow chart illustrating a process 600 for searching for images. In some embodiments, one or more of the functions described with respect to the process 600 can be performed (e.g., completely, partially, and/or the like) by a network service provider system (referred to herein as a network service provider). The network service provider can be the same as, or similar to, the network service provider 130 of FIG. 1. In some embodiments, the network service provider system can implement one or more functions described with respect to the data management service 132 as discussed herein. While process 600 is described herein with respect to certain computing devices, in some embodiments one or more of the steps of process 600 can be performed by another device or a group of devices separate from and/or including the network service provider, such as one or more vehicles (e.g., one or more devices installed on vehicles that are the same as, or similar to, the vehicles 120 as described herein).

As shown in FIG. 6, at step 602, the network service provider obtains data associated with an input representing a query including one or more semantic elements. For example, an individual operating a computing device (e.g., one or more parties as described herein such as, for example, an automated vehicle developer that can be operating a computing device that is the same as, or similar to, the computing device 140 as described herein) can provide input to the computing device via an input device (e.g., a keyboard, a mouse, and/or the like). The input can represent a query that includes one or more semantic elements. In some embodiments, the one or more semantic elements can include (e.g., represent) the presence (or non-presence) of a vehicle, a pedestrian, an object, a drivable surface, a non-drivable surface, one or more conditions (e.g., one or more weather conditions, lighting conditions, and/or the like) and/or the like.

In some embodiments, the data associated with the input can cause the network service provider to provide portions of vehicle data (e.g., data associated with the operation of a vehicle as described herein) responsive to the query. For example, the input can be configured to cause the network service provider to scan through a data store, the data store including vehicle data associated with one or more images, one or more video clips, one or more operational parameters, and/or the like as generated during automated or non-automated operation of a vehicle.

At step 604, the network service provider extracts an embedding representing the one or more semantic elements based on the query. For example, the network service provider can extract an embedding based on the network service provider providing the data associated with the input representing the query to a model. In this example, where the model is a contrastive representation learning model, the network service provider can provide the data associated with the input representing the query to an encoder of the model that is configured to receive the data (e.g., an encoder configured to receive text). In some embodiments, the network service provider can receive an output from the model based on providing the data associated with the input to the respective encoder. For example, the network service provider can receive an output representing an embedding. In this example, the embedding can include a vector representation of the sematic elements included in the query.

In some embodiments, the embeddings described herein can represent one or more sematic elements. For example, a query can be associated with a string of text such as “driving into a tunnel at night,” can include a first semantic element “a tunnel” and a second semantic element “at night.” In some embodiments, the semantic elements can include a greater or fewer number of elements that can be used to describe a scenario represented by an image.

In some embodiments, the embedding output by the model (e.g., output by an encoder of the model) can be associated with a shared latent space. For example, the embedding output by the model can be a vector representation that can similarly be associated with other vector representations. In some embodiments, the other vector representations can include vector representations generated by one or more other encoders of the model. For example, the model can include a text encoder and an image encoder. In this example, the text encoder can be configured to receive the data associated with the input and generate the embedding corresponding to the text. Similarly, the image encoder can be configured to receive data associated with at least one image and generate an embedding (e.g., a vector representation) corresponding to the image. In this example, the text encoder and the image encoder can be trained (e.g., based on pairs of descriptive text indicating one or more features of images as well as a corresponding images) such that they are configured to generate embeddings that are correlated. As described herein the correlation of the embeddings can be determined based on a cosine similarity (e.g., a distance as measured in the latent space) between the embeddings.

At step 606, the network service provider compares the embedding to at least one predetermined embedding of a set of predetermined embeddings. For example, the network service provider can compare the embedding generated by the text encoder of the model to the at least one predetermined embedding generated by a different encoder. In some embodiments, the network service provider can compare the embedding generated by the text encoder of the model to at least one predetermined embeddings generated by an image encoder of the model. The at least one predetermined embedding can be generated by the image encoder based on (in response to) receiving data associated with one or more images. In these examples, the embeddings that can be generated using the text encoder and the embeddings that can be generated using the different encoders (e.g., an image encoder and/or the like) can be configured to generate embeddings associated with a shared latent space. As described herein, the one or more predetermined embeddings can be updated (e.g., added to, removed from, and/or the like) as additional data is encoded using the encoders of the model.

In some examples, the network service provider can compare the embedding to the at least one predetermined embedding based on a distance between the embedding and the one or more predetermined embeddings. For example, the network service provider can generate the embedding and the at least one predetermined embedding such that the embeddings are associated with a shared latent space. The shared latent space can include a plurality of numerical representations in a high-dimensional space, where portions of the numerical representations correspond to semantic elements (e.g., features that can be identified in images) described herein. In these examples, the network service provider can determine a cosine similarity between the embedding and the at least one predetermined embedding when comparing the embedding to the at least one predetermined embedding.

As described herein, the one or more predetermined embeddings can be included in a set of predetermined embeddings corresponding to a set of images represented as data in a data store. In some embodiments, the set of predetermined embeddings can be generated and/or updated based on the encoders of the model. For example, as data associated with images is received from one or more vehicles based on operation of the vehicles in an environment, the network service provider can process the data. Processing the data can include providing the data associated with the images to respective encoders of the model and storing the output embeddings in association with the data associated with the images. In this way, the network service provider can generate a data store of images and corresponding predetermined embeddings to later be obtained from the data store and compared to embeddings generated based on queries. In these examples, the set of predetermined embeddings can be stored in a data store that is the same as, or similar to, the data store 134 and/or the database 706 as described herein.

At step 608, the network service provider selects the at least one predetermined embedding based on a degree of similarity between the embedding and the at least one predetermined embedding. For example, the network service provider can determine a degree of similarity between the embedding and the one or more predetermined embeddings and the network service provider can determine a cosine similarity based on the comparison. The network service provider can then identify one or more predetermined embeddings based on the cosine similarity. For example, the network service provider can one or more of the predetermined embeddings based on the embeddings being the closest cosine similarity when compared to the cosine similarity of other predetermined embeddings. Additionally, or alternatively, the network service provider can compare the cosine similarities to a similarity threshold. In some embodiments, the similarity threshold can be a threshold that is set (e.g., by a party operating a computing device to generate queries as described herein). In these examples, where the cosine similarity satisfies the similarity threshold, the network service provider can select the predetermined embeddings.

In some embodiments, the network service provider can select a first predetermined embedding and at least one second predetermined embedding based on a second degree of similarity. For example, the network service provider can select the first predetermined embedding and determine one or more cosine similarities between the first predetermined embedding and one or more other embeddings of the set of predetermined embeddings. In this example, the at least one second predetermined embedding can be selected based on a degree of similarity that is greater than, equal to, and/or less than the first degree of similarity. In this way, the network service provider can select a subset of embeddings that are in a similar portion of the shared latent space and represent similar features.

At step 610, the network service provider provides data associated with an image corresponding to the at least one predetermined embedding. For example, the network service provider can select the one or more predetermined embeddings and identify corresponding portions of the data associated with the images in the data store. In some embodiments, the network service provider can then provide the corresponding portions of the data associated with the images to a computing device that is controlled by the party that generated the query. For example, the network service provider can aggregate the subsets of data associated with the images based on selecting the one or more predetermined embeddings and provide the subsets of data to the computing device controlled by the party that generated the query. In this example, the subsets of data can include data associated with a first image and one or more second images selected based on the first image (e.g., one or more second images with embeddings that satisfy a second similarity threshold as compared to the first image).

In some embodiments, the network service provider can provide the data associated with the image corresponding to the at least one predetermined embedding to a system maintaining a training dataset. For example, the network service provider can provide the data associated with the at least one predetermined embedding to a computing device that is controlled by the party that generated the query, where the party is causing the computing device to initiate training and/or updating of one or more machine learning models. In this example, the data associated with the image corresponding to the at least one predetermined embedding can be provided to a machine learning model that is implemented by a vehicle autonomous driving system that is the same as, or similar to, the vehicle autonomous driving system 210 described herein.

In some embodiments, the network service provider can cause the computing device controlled by the party that generate the query to display a graphical user interface (GUI). For example, the GUI can represent a set of images including the images associated with (e.g., corresponding to) the predetermined embeddings that were selected. The network service provider can provide data associated with the GUI to the computing device controlled by the party that generated the query along with a request for input at the computing device. In some embodiments, the network service provider can then obtain data associated with a second input provided by the party that generated the query. For example, the network service provider can receive data associated with the second input which can include an indication of selection of a different image represented by the GUI (e.g., an image that is responsive to the query and different from the image corresponding to the first predetermined embedding). In some embodiments, the network service provider can determine one or more different predetermined embeddings based on the indication of the selection of the different image. For example, the network service provider can determine the one or more predetermined embeddings by comparing the predetermined embedding corresponding to the selected image to predetermined embeddings of the set of predetermined embeddings. The network service provider can then select at least one third predetermined embedding based on a degree of similarity between the predetermined embedding corresponding to the selected image and predetermined embeddings of the set of predetermined embeddings. This process can be iteratively performed as many times as desired by the party that generated the query until a desired set of images is selected.

In some embodiments, the network service provider can then obtain data associated with a second input which can include an indication of selection of a different image represented by the GUI to be excluded. In some embodiments, the network service provider can determine one or more different predetermined embeddings based on the indication of the selection of the different image to be excluded. For example, the network service provider can compare the predetermined embedding corresponding to the image to be excluded to predetermined embeddings of the set of predetermined embeddings. The network service provider can then exclude (e.g., remove from selection) at least one third predetermined embedding based on a degree of similarity between the predetermined embedding corresponding to the selected image and predetermined embeddings of the set of predetermined embeddings. This process can be iteratively performed as many times as desired by the party that generated the query until a desired set of images is selected.

In some embodiments, the network service provider provides data associated with an image corresponding to the at least one predetermined embedding to a system operating on a vehicle such as one or more components of the vehicles 120. For example, the network service provider can transmit the data associated with one or more images and/or one or more embeddings corresponding to the one or more images to a system (e.g., a computing device) installed on a vehicle and configured to collect and store sensor data generated during operation of the vehicle. The data associated with the one or more images and/or one or more embeddings can be configured to cause the system installed on the vehicle to identify and store certain portions of vehicle data such as portions of the vehicle data that matches the one or more images and/or one or more embeddings. In this example, the image encoder described herein can be executed by the system installed on the vehicle and used by the system to filter the sensor data generate during operation of the vehicle. The sensor data can then be uploaded (e.g., intermittently, when operation of the vehicle is completed, and/or the like) to the network service provider system. In this way, the vehicle can be operated and collect sensor data relevant to a query without storing data that is not relevant to the query. This can result in conserved computing resources and faster uploads of the data to the network service provider by the system installed on the vehicle.

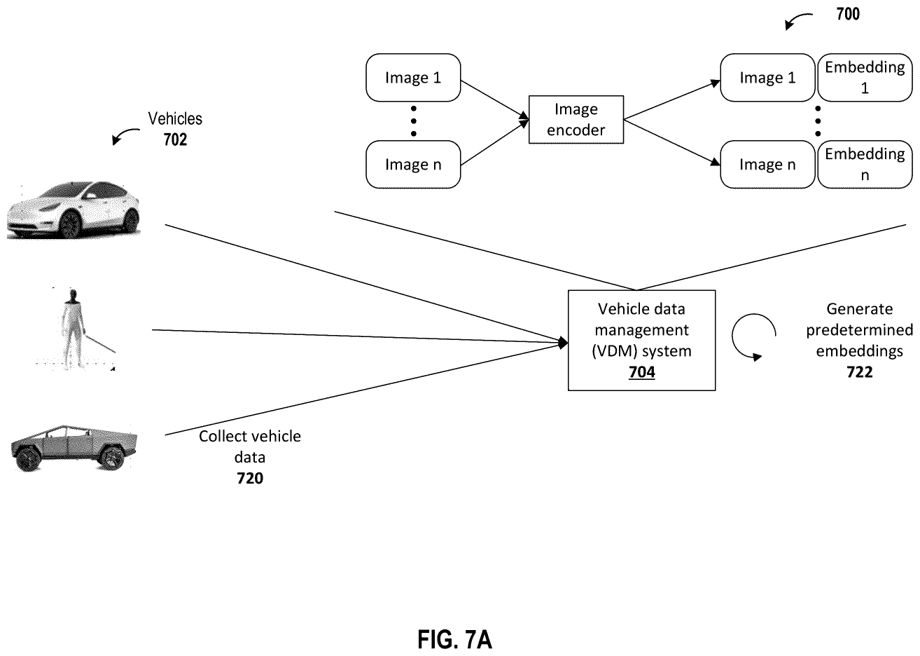

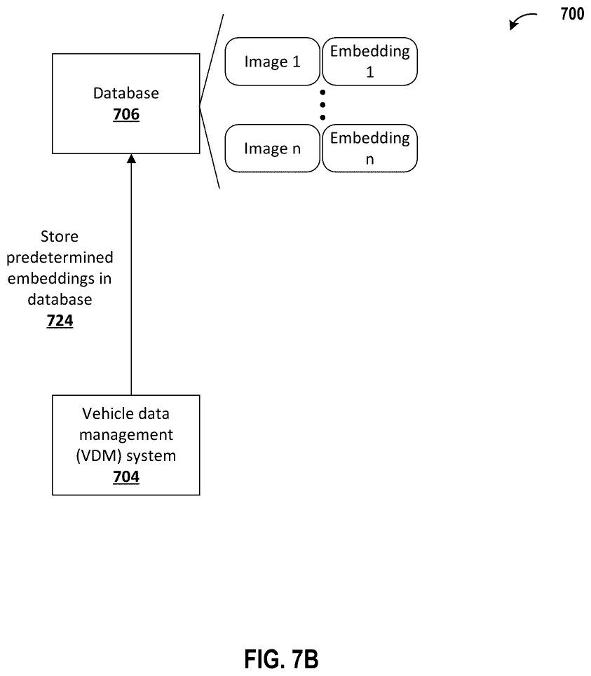

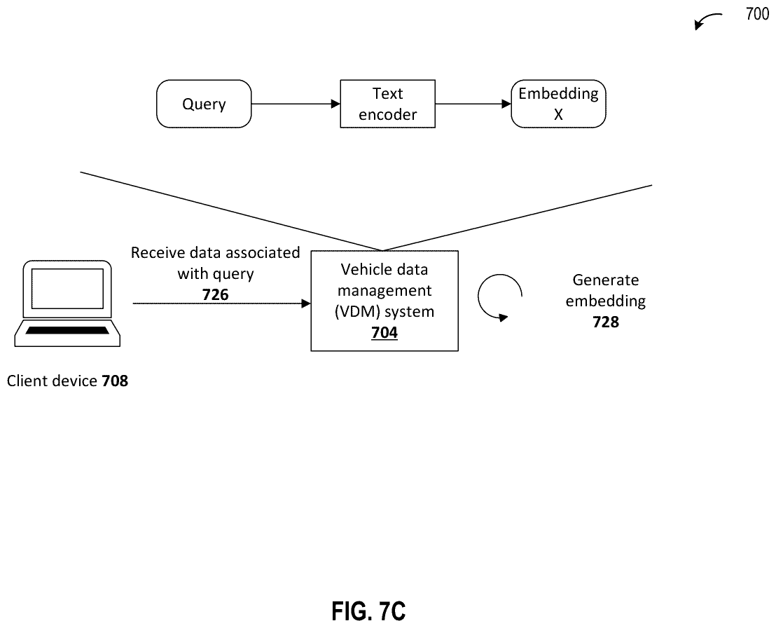

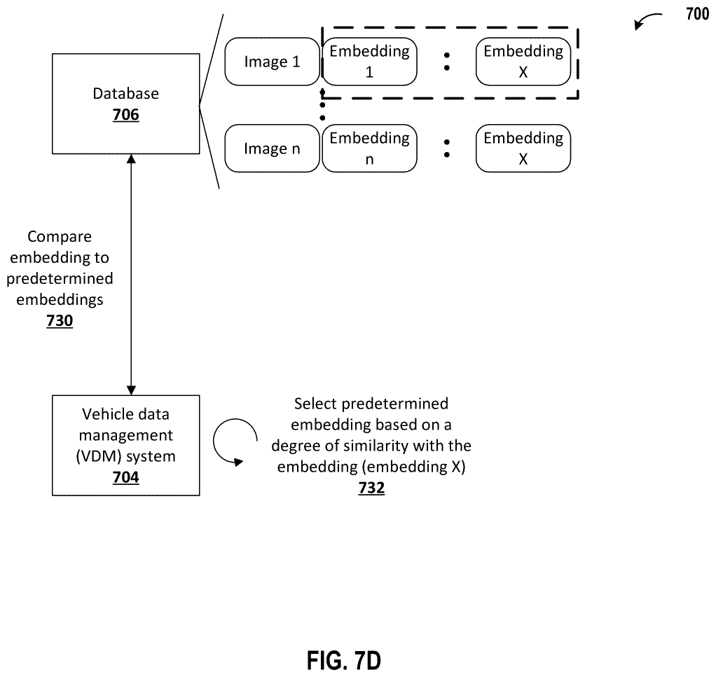

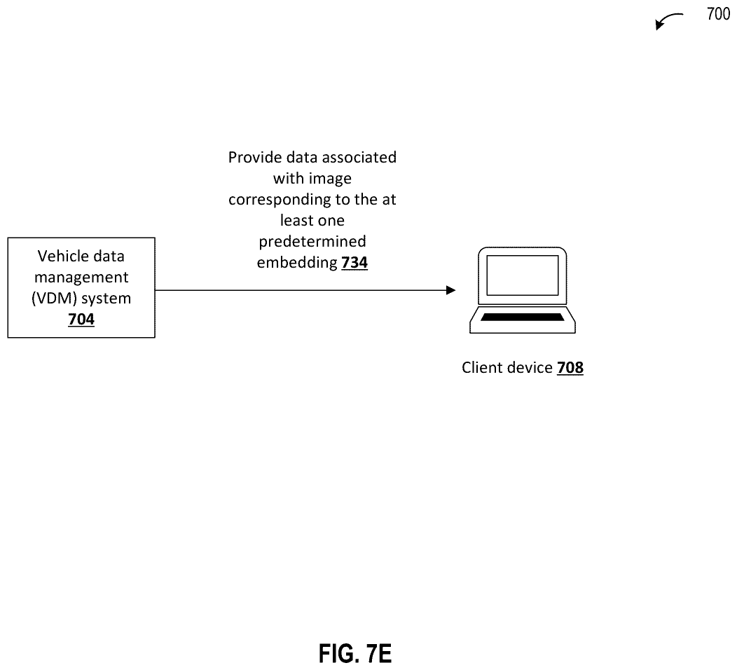

FIGS. 7A-7E depict a schematic diagram of an example implementation of a process for searching for images. In some embodiments, the vehicles 702, vehicle data management system 704, database 706, and client device 708 can be the same as, or similar to, the vehicles 102, the network service provider system 130 (implementing the vehicle data management service 132), the data store 134, and the computing devices 140, as described herein.

At step 720, the vehicle data management system 704 (also referred to as the VDM system 704) receives vehicle data. The vehicle data can include the data described herein, including data associated with images generated by sensors (e.g., cameras and/or the like) supported by the vehicles 702, data associated with a state of the vehicles, and/or the like.

At step 722, the VDM system 704 generates predetermined embeddings. For example, the VDM system 704 can generate the predetermined embeddings by providing the data associated with the images to an image encoder. In this example, the image encoder can be an encoder included in a model such as, for example, a contrastive representation learning model. The VDM system 704 can provide the data associated with the images to the encoder to cause the encoder to provide an output, the output including corresponding embeddings (e.g., vector representations). The VDM system 704 can iteratively perform this process as additional data associated with images is received.

At step 724, the VDM system 704 stores the predetermined embeddings in a database 706. For example, the VDM system 704 can store the predetermined embeddings in the database 706 in association with corresponding subsets of data associated with images used to generate the predetermined embeddings.

At step 726, the VDM system 704 receives data associated with a query from a client device 708. The data associated with the query can be generated by the client device 708 based on input provided by a party as described herein, such as an automated vehicle developer. In examples, the query includes one or more semantic elements. For example, the query can include “images of tunnels with vehicles approaching the tunnel entrance” where the semantic elements include “tunnels” “vehicles” “vehicles approaching” and “tunnel entrance.”

At step 728, the VDM system 704 generates embeddings based on the query. For example, the VDM system 704 can generate the embeddings by providing the data associated with the query to a text encoder. In this example, the text encoder can be an encoder included in a model such as, for example, the contrastive representation learning model that includes the image encoder. The VDM system 704 can provide the data associated with the query to the encoder to cause the encoder to provide an output, the output including an embedding (e.g., vector representations) of the query.

At step 730, the VDM system 704 compares the embedding corresponding to the query to the predetermined embeddings. For example, the VDM system 704 can scan the database 706 and compare the embedding corresponding to the query to the predetermined embeddings in the database 706. In this example, the VDM system 704 can compare the embedding corresponding to the query to the predetermined embeddings based on a cosine similarity (e.g., a distance as measured in the latent space) between the embeddings.

At step 732, the VDM system 704 selects one or more predetermined embeddings stored in the database 706. For example, the VDM system 704 can select the one or more predetermined embeddings based on the cosine similarity between the predetermined embeddings and the embedding corresponding to the query.

At step 734, the VDM system 704 provides the data associated with image corresponding to the at least one predetermined embedding to the client device 708. For example, the VDM system 704 can provide the data associated with image corresponding to the at least one predetermined embedding to the client device 708 to cause the client device 708 to display the image.

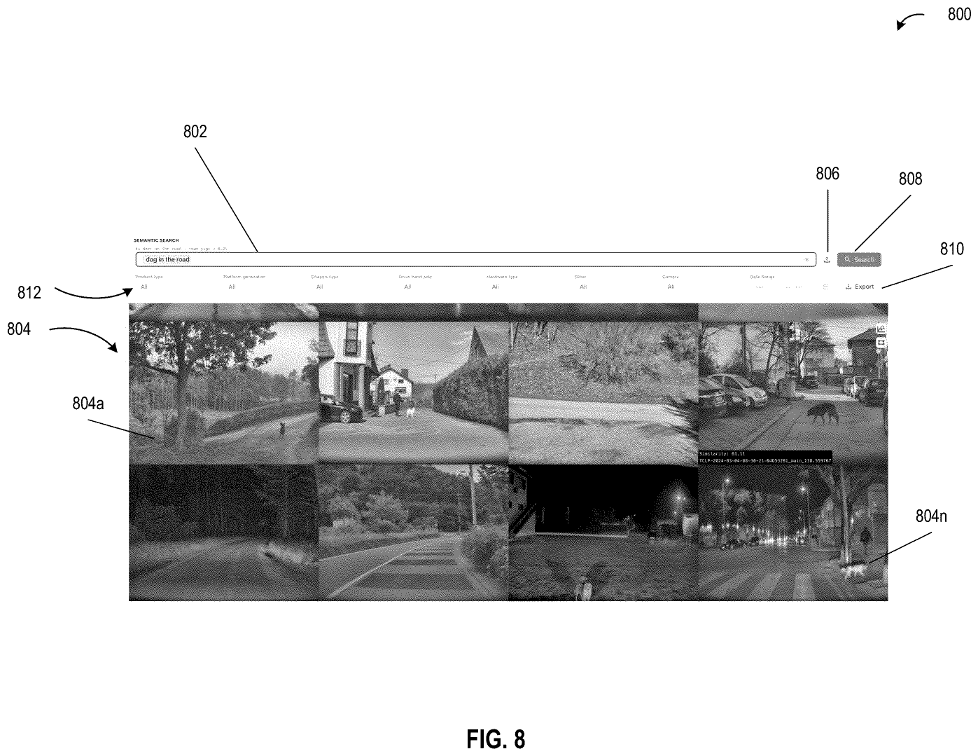

FIG. 8 depicts an example graphical user interface (GUI) 800. The GUI 800 includes an input field 802, a display region 804, a download button 806, a search button 808, an export button 810, and one or more drop-down menus 812.

In some embodiments, the input field 802 of the GUI 800 can be configured to receive input provided by a party via a computing device (e.g., a computing device that is the same as, or similar to, the computing device 140 and/or the client device 708 as described herein). The input can include text input (e.g., a string of text). In examples, the input can also include images (e.g., provided as input by the parties by selecting an image displayed in the display region 804).

In some embodiments, the display region 804 can include a plurality of subregions 804a-804n. The plurality of subregions 804a-804n can display one or more images. For example, as described herein, the computing device can receive data associated with images from a network service provider 130 or a VDM system 704 and display the images in one or more of the subregions 804a-804n.

In some embodiments, the download button 806 can be selected based on input provided by the party operating the computing device. The download button 806 can cause the computing device to save (e.g., store) the query represented by the text and/or image representations included in the input field 802.

In some embodiments, the search button 808 can be selected based on input provided by the party operating the computing device. For example, after providing and/or updating a query, the party operating the computing device can provide input to select the search button 808. In this example, the selection of the search button 808 can cause the computing device to provide data associated with the input (e.g., the query) to a network service provider or VDM system as described herein.

In some embodiments, the export button 810 can be selected based on input provided by the party operating the computing device. For example, the export button 810 can be selected to cause the computing device to download and/or otherwise transfer the data associated with the images in the display region 804 to a training dataset. In some embodiments, the parties operating the computing device can provide input to the computing device selecting one or more of the subregions 804a-804n and the computing device can download and/or otherwise transfer the data associated with the images selected to the training dataset.

In some embodiments, the one or more drop-down menus 812 can be selected based on input provided by the party operating the computing device. For example, the one or more drop-down menus 812 can be selected to cause the computing device to refine the images represented by one or more of the subregions 804a-804n. Examples of refinements (selective inclusions or exclusions) can include refining the images based on a product type (e.g., a software product such as one or more programs executed by the vehicle autonomous driving system 210), the platform generation (e.g., the make of one or more of the vehicles described herein), the chassis type (e.g., the model of one or more of the vehicles described herein), an indicator of one or more configurations of the vehicle (e.g., whether the vehicle is a left-hand drive or right-hand drive vehicle), a hardware type indicating the model of the computing device and/or sensors of the vehicle, a camera type and/or position relative to the vehicle, and a date range (e.g., a range of dates during which the vehicle data corresponding to the images was generated).

Various embodiments of the present disclosure can be a system, a method, and/or a computer program product at any possible technical detail level of integration. The computer program product can include a non-transitory computer readable storage medium (or mediums) having computer readable program instructions (also referred to as “instructions”) thereon that, when executed by at least one processor, cause the at least one processor to carry out one or more operations associated with aspects of the present disclosure.

For example, the functionality described herein can be performed as software instructions are executed by, and/or in response to software instructions being executed by, one or more hardware processors and/or any other suitable computing devices. The software instructions and/or other executable code can be read from a computer readable storage medium (or mediums).

The computer readable storage medium can be a tangible device that can retain and store data and/or instructions for use by an instruction execution device. The computer readable storage medium can be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions can be callable from other instructions or from itself, and/or can be invoked in response to detected actions or interrupts. Computer readable program instructions configured for execution on computing devices can be provided on a computer readable storage medium, and/or as a digital download (and can be originally stored in a compressed or installable format that requires installation, decompression or decryption prior to execution) that can then be stored on a computer readable storage medium. Such computer readable program instructions can be stored, partially or fully, on a memory device (e.g., a computer readable storage medium) of the executing computing device, for execution by the computing device. The computer readable program instructions can execute entirely on a user's computer (e.g., the executing computing device), partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry, including, for example, programmable logic circuitry, field-programmable gate arrays (FPGA), or programmable logic arrays (PLA), can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions can initially be carried on a magnetic disk or solid-state drive of a remote computer. The remote computer can load the instructions and/or modules into its dynamic memory and send the instructions over a telephone, cable, or optical line using a modem. A modem local to a server computing system can receive the data on the telephone/cable/optical line and use a converter device including the appropriate circuitry to place the data on a bus. The bus can carry the data to a memory, from which a processor can retrieve and execute the instructions. The instructions received by the memory can optionally be stored on a storage device (e.g., a solid-state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. In addition, certain blocks can be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections can be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which can also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, can be referred to herein as, for example, “computers,” “devices,” “computer devices,” “computing devices,” “hardware computing devices,” “hardware processors,” “processing units,” and/or the like. Computing devices of the above-embodiments can generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices can be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality can be accessible by a user through a web-based viewer (such as a web browser), or other suitable software program. In such implementations, the user interface can be generated by a server computing system and transmitted to a web browser of the user (e.g., running on the user's computing system). Alternatively, data (e.g., user interface data) necessary for generating the user interface can be provided by the server computing system to the browser, where the user interface can be generated (e.g., the user interface data can be executed by a browser accessing a web service and can be configured to render the user interfaces based on the user interface data). The user can then interact with the user interface through the web-browser. User interfaces of certain implementations can be accessible through one or more dedicated software applications. In certain embodiments, one or more of the computing devices and/or systems of the disclosure can include mobile computing devices, and user interfaces can be accessible through such mobile computing devices (for example, smartphones and/or tablets).

Many variations and modifications can be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “can,” unless specifically stated otherwise, or otherwise understood within the context as used, is generally intended to convey that certain embodiments include, while other embodiments can not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z,” or “at least one of X, Y, or Z,” unless specifically stated otherwise, is to be understood with the context as used in general to convey that an item, term, etc. can be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and can possibly include such components as memory, input/output devices, and/or network interfaces, among others.

Some embodiments and examples of the present disclosure are described herein in connection with a threshold. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

While the above detailed description has shown, described, and pointed out novel features as applied to various embodiments, it can be understood that various omissions, substitutions, and changes in the form and details of the devices or processes illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated the appended claims rather than by the foregoing description. All changes which come within the meaning and range of equivalency of the claims are to be embraced within their scope.

What is claimed is:

1. A method, comprising:
obtaining, by at least one processor, data associated with an input representing a query, the query comprising one or more semantic elements;
extracting, by the at least one processor, an embedding representing the one or more semantic elements based on the query;
comparing, by the at least one processor, the embedding to at least one predetermined embedding of a set of predetermined embeddings;
selecting, by the at least one processor, the at least one predetermined embedding based on a degree of similarity between the embedding and the at least one predetermined embedding; and
providing, by the at least one processor, data associated with a graphical user interface (GUI) to cause a display device to display the GUI representing a set of images comprising an image corresponding to the at least one predetermined embedding,
wherein the one or more semantic elements at least in part correspond to one or more objects represented by the image.

2. The method of claim 1, wherein extracting the embedding representing the one or more semantic elements based on the input comprises:
providing, by the at least one processor, the data associated with the input to a text encoder to cause the text encoder to generate the embedding.

3. The method of claim 1, further comprising:
obtaining, by the at least one processor, the set of predetermined embeddings from a database, the set of predetermined embeddings generated based on images corresponding to the predetermined embeddings and an image encoder.

4. The method of claim 3, wherein the image encoder is configured to receive data associated with images generated by at least one sensor supported by at least one vehicle as input and provide embeddings associated with a latent space as output.

5. The method of claim 1, wherein the at least one predetermined embedding comprises at least one first predetermined embedding,
the method further comprising:
selecting, by the at least one processor, at least one second predetermined embedding of the set of predetermined embeddings based on a second degree of similarity between the at least one second predetermined embedding and other predetermined embeddings of the set of predetermined embeddings.

6. The method of claim 1, wherein the input comprises a first input, the method further comprising:
obtaining, by the at least one processor, data associated with a second input, the second input indicating selection of a different image represented by the GUI,
determining, by the at least one processor, at least one second predetermined embedding based on the selection of the different image represented by the GUI, and
selecting, by the at least one processor, at least one third predetermined embedding based on a degree of similarity between the at least one second predetermined embedding and embeddings of the set of predetermined embeddings.

7. The method of claim 6, wherein the second input indicates selection of the different image that corresponds to a different embedding of the set of predetermined embeddings.

8. The method of claim 1, wherein the embedding and the set of predetermined embeddings comprise vector representations corresponding to one or more features in a shared latent space.

9. The method of claim 1, wherein selecting the at least one predetermined embedding based on the degree of similarity between the embedding and the at least one predetermined embedding comprises:
determining that the degree of similarity between the embedding and the at least one predetermined embedding satisfies a similarity threshold; and
selecting the at least one predetermined embedding based on the degree of similarity satisfying the similarity threshold.

10. A system, comprising:
one or more processors configured to:
obtain data associated with an input representing a query, the query comprising one or more semantic elements;
extract an embedding representing the one or more semantic elements based on the query;
compare the embedding to at least one predetermined embedding of a set of predetermined embeddings;
select the at least one predetermined embedding based on a degree of similarity between the embedding and the at least one predetermined embedding; and
provide data associated with a graphical user interface (GUI) to cause a display device to display the GUI representing a set of images comprising an image corresponding to the at least one predetermined embedding,
wherein the one or more semantic elements at least in part correspond to one or more objects represented by the image.

11. The system of claim 10, wherein the one or more processors configured to extract the embedding representing the one or more semantic elements based on the input are configured to:
provide the data associated with the input to a text encoder to cause the text encoder to generate the embedding.

12. The system of claim 11, wherein the one or more processors are further configured to:
obtain the set of predetermined embeddings from a database, the set of predetermined embeddings generated based on images corresponding to the predetermined embeddings and an image encoder.

13. The system of claim 11, wherein the image encoder is configured to receive data associated with images generated by at least one sensor supported by at least one vehicle as input and provide embeddings associated with a latent space as output.

14. The system of claim 10, wherein the at least one predetermined embedding comprises at least one first predetermined embedding, and
wherein the one or more processors are configured to:
select at least one second predetermined embedding of the set of predetermined embeddings based on a second degree of similarity between the at least one second predetermined embedding and other predetermined embeddings of the set of predetermined embeddings.

15. The system of claim 10, wherein the input comprises a first input, and
wherein the one or more processors are further configured to:
obtain data associated with a second input, the second input indicating selection of a different image represented by the GUI,
determine at least one second predetermined embedding based on the selection of the different image represented by the GUI, and
select at least one third predetermined embedding based on a degree of similarity between the at least one second predetermined embedding and embeddings of the set of predetermined embeddings.

16. The system of claim 15, wherein the second input indicates selection of the different image that corresponds to a different embedding of the set of predetermined embeddings.

17. The system of claim 10, wherein the embedding and the set of predetermined embeddings comprise vector representations corresponding to one or more features in a shared latent space.

18. The system of claim 10, wherein the one or more processors configured to select the at least one predetermined embedding based on the degree of similarity between the embedding and the at least one predetermined embedding are configured to:
determine that the degree of similarity between the embedding and the at least one predetermined embedding satisfies a similarity threshold; and
select the at least one predetermined embedding based on the degree of similarity satisfying the similarity threshold.

19. A non-transitory computer-readable medium storing instructions thereon that, when executed by one or more processors, cause the one or more processors to:
obtain data associated with an input representing a query, the query comprising one or more semantic elements;
extract an embedding representing the one or more semantic elements based on the query;
compare the embedding to at least one predetermined embedding of a set of predetermined embeddings;
select the at least one predetermined embedding based on a degree of similarity between the embedding and the at least one predetermined embedding; and
provide data associated with a graphical user interface (GUI) to cause a display device to display the GUI representing a set of images comprising an image corresponding to the at least one predetermined embedding,
wherein the one or more semantic elements at least in part correspond to one or more objects represented by the image.

20. The non-transitory computer-readable medium of claim 19, wherein the instructions to extract the embedding representing the one or more semantic elements based on the input cause the one or more processors to:
provide the data associated with the input to a text encoder to cause the text encoder to generate the embedding.
